(19) United States
(12) Patent Application Publication
(10) Pub. No.: US 2026/0029327 A1
(43) Pub. Date: Jan. 29, 2026

(54) MATERIAL MEASUREMENT SYSTEM

(71) Applicant: GROWMARK, Inc., Bloomington, IL (US)

(72) Inventors: Austin FALCONER, Bloomington, IL (US); Jesse RUEGSEGGER, Congerville, IL (US); Mitchel THORSEN, Madison, WI (US); John CAYA, McFarland, WI (US)

(21) Appl. No.: 19/280,607

(22) Filed: Jul. 25, 2025

Related U.S. Application Data
(60) Provisional application No. 63/676,001, filed on Jul. 26, 2024.

(51) Int. Cl. G01N 21/01; G01N 21/15

(52) U.S. Cl. CPC G01N 21/01; G01N 2021/0118; G01N 2021/0181; G01N 2021/151; G01N 2201/0225; G01N 2201/0227; G01N 2201/127

(57) ABSTRACT

An imaging pod for capturing image data of a surface of a material stockpile, includes a housing including selectively a moveable door, an image sensor disposed within the housing and selectively revealeable responsive to the selective movement of the door. When the image sensor is revealed, the image sensor is configured to capture the image data of the surface of the stockpile.

### CROSS-REFERENCE TO RELATED APPLICATIONS

This application claims the benefit of priority pursuant to 35 U.S.C. § 119(e) of U.S. Provisional Patent Application No. 63/676,001, filed Jul. 26, 2024, entitled “MATERIAL MEASUREMENT SYSTEM,” which is hereby incorporated by reference herein in its entirety.

### BACKGROUND

Materials such as grain, fertilizer, salt, aggregate, cement, etc., are often stored in stockpiles in storage facilities such as warehouses or silos. Measuring the amount of these materials in such facilities is traditionally accomplished by using level probes that contact the surface of a stockpile of the commodity to take a point measurement. In other instances, the piles may be measured by physically leveling the pile and utilizing elevation markings on the bin walls in conjunction with lengths/widths to determine area canulations. However, such methods are prone to widespread error, as most commodity piles or other storage volumes exhibit irregular, shifting shapes that cannot be acutely or repeatably measured with point contact probes. Furthermore, level probes typically are most effective in instances where the materials are constrained on all sides and flow fluidly (e.g., in a silo) as compared to other storage configurations (e.g., warehouses) where stockpiles are not side-constrained or products that are prone to cliffing, leading to inaccurate “top” level measurement and the like.

In open warehouses, other measurement methods include weighing of materials as they enter, leave, or reside in a storage facility. Such methods can be inaccurate. For example, often facilities are not equipped with whole-floor scales, requiring that materials be moved onto separate scales to be weighted. Many facilities, e.g., road salt facilities for transportation agencies, do not track in-bound and out-bound material and rely instead on number of orders and estimated volume out per truck.

Furthermore, the environments within such storage facilitate are challenging for sensitive instruments to operate in reliably. The facilities are often dusty (e.g., in sugar or coal storage facilities), some of which may be corrosive dusts (e.g., in fertilizer or salt storage facilities). Even non-reactive dusts can cause failure of scales and traditional level probes by accumulating and blocking the functional parts of traditional measurement systems. Similarly, the environments may have hot temperatures, high humidity or dampness, include other debris and vermin, which can make electronic equipment error prone or induce failure.

Furthermore, locations where materials are constrained may become inaccessible or have limited accessibility increasing the difficulty of persons or mobile equipment from accurately measuring materials in a safe and efficient manner. Certain materials in both constrained and unconstrained environments may be difficult to safely traverse.

### BRIEF SUMMARY

A system for measuring an amount of a material, includes: a first imaging pod positioned at a first position relative to a stockpile of the material; a second imaging pod in communication with the first imaging pod and positioned at a second position relative to the stockpile of material different than the first position; a processor configured to: receive the data about the stockpile from the imaging pods; and determine a characteristic of the stockpile based on the data.

Optionally, in some embodiments, the characteristic includes an amount of the material.

Optionally, in some embodiments, the processor is further configured to: determine a composite surface model based on the data; receive a bulk density of the material; and determine the amount of the material based on the composite surface material model and the bulk density.

Optionally, in some embodiments, the amount of the material includes at least one of a weight of the material, a volume of the material, a change in the weight of the material, or a change in the volume of the material.

Optionally, in some embodiments, the processor is further configured to receive calibration data about a storage facility configured to receive the stockpile, and generate the amount of the material based on the calibration data.

Optionally, in some embodiments, at least one of the first imaging pod or the second imaging pod includes: a housing including a selectively moveable door; a sensor disposed within the housing and selectively revealeable responsive to the selective movement of the door, wherein when the sensor is revealed, the sensor is configured to capture the data.

Optionally, in some embodiments, at least one of the first imaging pod or the second imaging pod further includes a drive assembly rotationally coupled to the door. The drive assembly rotationally floats with respect to the housing; and the drive assembly is selectively collapsible.

Optionally, in some embodiments, the sensor includes an image sensor.

Optionally, in some embodiments, the image sensor includes a LIDAR sensor.

Optionally, in some embodiments, the first imaging pod is configured as a primary imaging pod including the processor; the second imaging pod is configured as a secondary imaging pod; and the primary imaging pod is configured to command, via the processor, the secondary imaging pod to: activate a sensor in the secondary imaging pod; capture the data, via the sensor, of the stockpile from the second location; and transmit the data to the primary image pod.

Optionally, in some embodiments, the primary imaging pod and the secondary imaging pod are in wireless communication with one another.

Optionally, in some embodiments, the imaging pods are configured to reduce or remove debris from an image sensor coupled thereto.

A sensing pod for capturing data of a surface of a material stockpile, includes: a housing including a selectively moveable door; a sensor disposed within the housing and selectively revealeable responsive to the selective movement of the door, wherein when the sensor is revealed, the sensor is configured to capture the data of the surface of the stockpile.

Optionally, in some embodiments, the sensing pod includes a drive assembly rotationally coupled to the door.

Optionally, in some embodiments, the drive assembly rotationally floats with respect to the housing.

Optionally, in some embodiments, the drive assembly is selectively collapsible.

Optionally, in some embodiments, wherein the sensor includes a LIDAR sensor.

Optionally, in some embodiments, the sensing pod includes a sensor assembly including: the sensor; a stationary hub; a rotationally moveable rotor coupled to the hub; and an air mover coupled to the rotor. The sensor captures the image data, the rotor rotates relative to the hub and the rotation of the rotor causes the air mover to generate an airflow.

Optionally, in some embodiments, the airflow is configured to remove or prevent debris buildup on the sensing pod.

Optionally, in some embodiments, the sensing pod includes a mount configured to position the sensing pod relative to a support surface and relative to the stockpile.

Optionally, in some embodiments, the configuration of the position of the sensing pod is based, at least in part, on an angle of repose of the material.

Optionally, in some embodiments, the sensing pod includes a processing element configured to determine at least one of a weight or a volume of the material in the stockpile based on the data.

A method of determining an amount of a material, includes: receiving, by a processor, first image data of the material, from a first imaging pod; receiving, by the processor, second image data of the material from a second imaging pod at a different location than the first imaging pod relative to the amount of the material; stitching, by the processor, the first image data and the second image data together to generate a composite surface model of the material; receiving, by the processor, a bulk density of the material; receiving, by the processor, calibration data about the storage facility; and generating, by the processor, at least one of a weight or a volume of the amount of the material based on the composite surface material model, the bulk density, and the calibration data.

Optionally, in some embodiments, the processor is associated either the first imaging pod or the second imaging pod and the processor receives the second image data from the other of the first imaging pod or the second imaging pod.

A sensing assembly includes: a housing including: a compartment; a door positioned at least partially over the compartment and movable between a first position and a second position; and a drive assembly coupled to the door and configured to selectively move the door between the first position and the second position; a sensor assembly positioned within the compartment; a fan; and a controller in communication with the fan and the drive assembly, wherein the controller is configured to activate the fan and the drive assembly before or as the sensor assembly is activated to sense data.

Optionally, in some embodiments, the fan is configured to force air away from the compartment.

### BRIEF DESCRIPTION OF THE DRAWINGS

FIG. 1 is a schematic view of a material measurement system

FIG. 2 is an example visual output of the material measurement system of FIG. 1.

FIG. 3A is a perspective view of an embodiment of an imaging pod of the material measurement system of FIG. 1, in a first configuration.

FIG. 3B is a perspective view of an embodiment of an imaging pod of the material measurement system of FIG. 1, in a second configuration.

FIG. 3C is a partially exploded, perspective view of the imaging pod of FIG. 3A and FIG. 3B.

FIG. 3D is a section view of the imaging pod of FIG. 3A and FIG. 3B taken along section line 3D-3D of FIG. 3A.

FIG. 3E is a section view of the imaging pod of FIG. 3A and FIG. 3B taken along section line 3E-3E of FIG. 3B.

FIG. 3F is a section view of the imaging pod of FIG. 3A and FIG. 3B taken along section line 3F-3F of FIG. 3A.

FIG. 3G is an elevation view of an embodiment of a bottom cap of the imaging pod.

FIG. 3H is a section view of an embodiment of the imaging pod taken along section line 3F-3F of FIG. 3A.

FIG. 3I is a detail view of a portion of FIG. 3H.

FIG. 3J is a detail view of a portion of FIG. 3H.

FIG. 4 is a perspective view of an embodiment of an image sensor and fan assembly of the imaging pod of FIG. 3A and FIG. 3B.

FIG. 5A is a perspective view of an embodiment of a first door of the imaging pod of FIG. 3A and FIG. 3B.

FIG. 5B is a bottom plan view of the door of FIG. 5A.

FIG. 5C illustrates an aspect of the subject matter in accordance with one embodiment.

FIG. 5D illustrates an aspect of the subject matter in accordance with one embodiment.

FIG. 6A is an end elevation view of an embodiment of a second door of the imaging pod of FIG. 3A and FIG. 3B.

FIG. 6B is a section view of the door of FIG. 6A taken along section line 6B-6B of FIG. 6A.

FIG. 7A is a partially exploded, perspective view of an embodiment of a drive assembly of the imaging pod of FIG. 3A and FIG. 3B.

FIG. 7B is a partially exploded, perspective view of an end portion of the drive assembly of FIG. 7A.

FIG. 7C is a side elevation view of the drive assembly of FIG. 7A, in a first configuration.

FIG. 7D is a side elevation view of the drive assembly of FIG. 7A, in a second configuration.

FIG. 7E is a partially exploded, perspective view of an embodiment of a drive assembly of the imaging pod of FIG. 3A and FIG. 3B.

FIG. 7F is a side elevation view of the drive assembly of FIG. 7E, in a first configuration.

FIG. 7G is a side elevation view of the drive assembly of FIG. 7E, in a second configuration.

FIG. 8 is an elevation view of an embodiment of a mount suitable for use with the imaging pod of FIG. 3A and FIG. 3B.

FIG. 9 is a schematic showing embodiments of the imaging pod of FIG. 3A and FIG. 3B with embodiments of the mount of FIG. 8 in use in the material measurement system of FIG. 1.

FIG. 10 is a flow chart of an embodiment of a method of acquiring image data with an imaging pods of FIG. 3A and FIG. 3B.

FIG. 11 is a flow chart of an embodiment of a method of combining imaging data from two or more imaging pods of FIG. 3A and FIG. 3B.

FIG. 12 is a flow chart of an embodiment of a method of measuring a material using the material measurement system of FIG. 1.

FIG. 13 is a simplified block diagram of components of a computing system of the material measurement system of FIG. 1.

### DETAILED DESCRIPTION

The present disclosure includes system and methods to accurately measure and/or track changes of loose materials, such as fertilizer, grain, or the like. The systems are configured to operate robustly in harsh environments, such as those including exposure to heat, debris, dust, humidity, moisture, and caustic fumes.

As one example, imaging techniques are disclosed that capture image data of the surface structure of a material stockpile (or other volumetric configuration or collection of such material). The system includes one or more sensing pods, imaging pods, or imaging modules positioned at different locations relative to the stockpile (e.g., at three discrete locations) that capture data such as three-dimensional information, e.g., a point cloud or other three-dimensional (3D) surface information of the stockpile. The system stitches image data from different imaging pods to form a composite surface material model. The stockpile model, along with user input properties of the material such as the average bulk density of the material (and optionally calibration data about the storage facility), allow the system to accurately and repeatably measure the volume and approximate the weight (e.g., convert to a weight measurement) of the material in a storage facility and/or stockpile, including changes over time.

The sensors used in the imaging pods may be sensitive (e.g., impacted or damaged) easily by debris, moisture, and other elements commonly found in storage facilities used for loose bulk materials. For example, in some embodiments, the imaging pods use light detection and ranging (LIDAR) imaging sensors which are quite sensitive to dusts such as those generated by loose materials or otherwise such material storage facilities. To help protect against damage, the imaging pods include selectively retractable doors and complementary seals that reduce exposure of the imaging sensors (as well as other components) to the environment, such as when not in use. For example, the doors may be opened only briefly as measurements are taken. Furthermore, mitigation elements, such as air moving elements (e.g., fans), can be included that are activated with and/or before the door(s) are open. These mitigation elements help to force particulate matter away from the sensors and interior of the pod while the sensor and interior are exposed or about to be exposed to the environment. This helps to prevent accumulation of debris or the like on the sensor or within the interior elements of the imaging pod. Such features enable the system to be relatively robust and error free, even while operating in harsh environments.

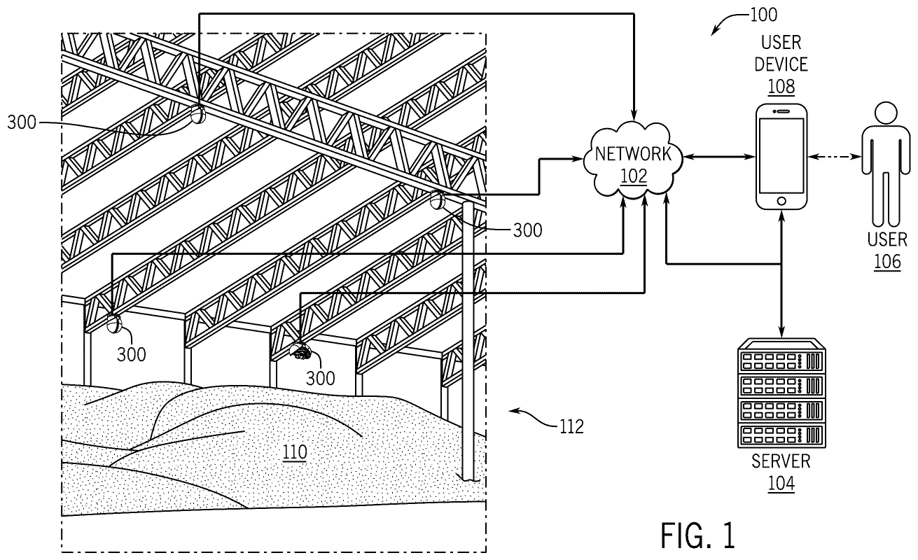

Turning to the figures, FIG. 1 shows a schematic view of an embodiment of a measurement system 100, including a perspective view of an example of a stockpile 110 of a material suitable to be measured by the system 100. In many examples, the system 100 is adapted to measure an amount of a loose, granular material. The systems and methods disclosed herein are also suitable for measuring amounts of other materials such as liquids, materials that can behave like liquids (e.g., powdered cement), slurries, pastes, colloids, mixtures of liquids and solids, and even materials with large particles such as boulders, bricks, blocks, and/or rip-rap. For example, a loose, granular material may be powdered cement, where any two given particles from a particular batch of dry cement have substantially the same chemical content and are similar in size and shape. In other examples, a loose, granular material may have a wide range of particle sizes. For example, ready-mix powdered concrete includes both very fine cement particles (e.g., on the order of 10-20 μm in size) with substantially larger aggregate particles (e.g., on the order of 10-20 mm in size). In some examples, a material may have a low moisture content and be substantially dry. In other examples, the material may have a high moisture content (e.g., particles of clay). In some examples, a material may have particles of different chemical composition, such as fertilizer mixes that contain particles with high nitrogen content like urea, particles with high potassium content such as potash, etc.

For various granular materials, bulk density is used as a characteristic measurement. This is the mass of the material per unit volume the material occupies, including both the granules and the voids (spaces) between the granules. Bulk density is typically expressed in units of mass per unit volume (e.g., kilograms per cubic meter (kg/m³) or pounds per cubic foot (lb./ft³)). Bulk density can vary for a given material depending on factors such as moisture content, particle size distribution, compaction, and the handling processes the commodity has undergone.

Some materials, such as loose, granular materials also exhibit an angle of repose, as shown for example in the stockpile 110 of FIG. 1. The angle of repose is the steepest angle at which a stockpile of unconsolidated loose, granular material remains stable. It is the maximum slope angle formed by the surface of the stockpile and the horizontal plane, beyond which the material begins to slide or flow. The angle of repose reflects the frictional force resisting downward movement among the particles and is influenced by factors such as particle shape, size, surface texture, and moisture content. The angle of repose combined with the aforementioned environmental factors often cause materials to exhibit irregular, shifting stockpile shapes which make traditional methods of measuring the weight and/or volume of the loose, granular material difficult or impossible to measure with traditional methods.

The measurement system 100 includes a network 102, one or more imaging pods 300 and may also include one or more user devices 108 and a server 104 or another computing device. The measurement system 100 is configured to acquire imaging data of the stockpile 110 from the imaging pods 300 and from that image data, determine an amount of the material in the stockpile 110. The one or more imaging pods 300 may be in communication with one another or other devices (such as the server 104 and/or the user device 108) either directly, or via the network 102. For example, the imaging pods 300 may be in communication with the server 104, which may in turn be in communication with the user device 108, either directly or through the network 102.

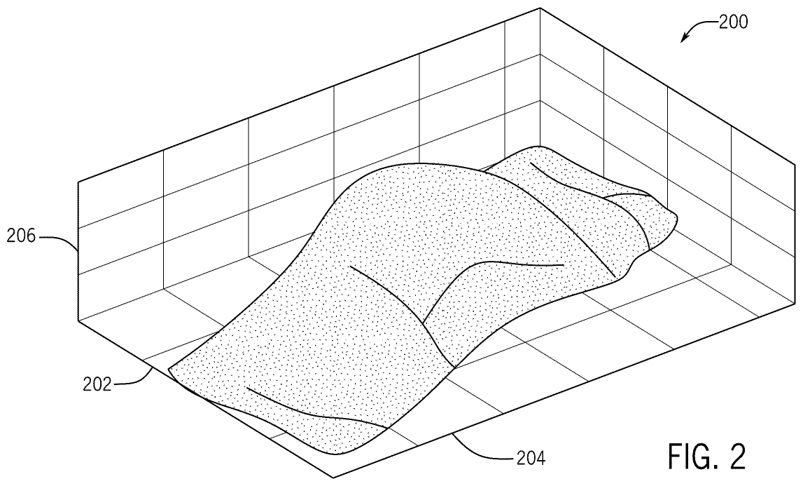

Turning to FIG. 2, an output of the measurement system 100 is shown. In some embodiments, the output of the measurement system 100 is a composite surface material model 200. The composite surface material model 200 is generated from image data captured by the one or more imaging pods 300. The composite surface material model 200 has dimensions measured along one or more coordinate axes, such as a Cartesian an x-axis 202, y-axis 204, and a z-axis 206. The axes may be mutually orthogonal to one another. In some embodiments, the composite surface material model 200 may have extents measured in polar or other coordinate systems.

The composite surface material model 200 generated based on the detected data by the system 100 includes volume data representative of the stockpile 110. Optionally, the model includes characteristic or property data of the material (e.g., bulk density). The composite surface material model 200 may track changes in the amount (either or both of volume and/or mass) of the material over time. For example, where material is added or withdrawn from the stockpile 110, or the stockpile settles and the material forming the stockpile 110 densifies over time. The methods by which the measurement system 100 generates the composite surface material model 200 are discussed in more detail with respect to the method 1000, the method 1100, and the method 1200 disclosed herein.

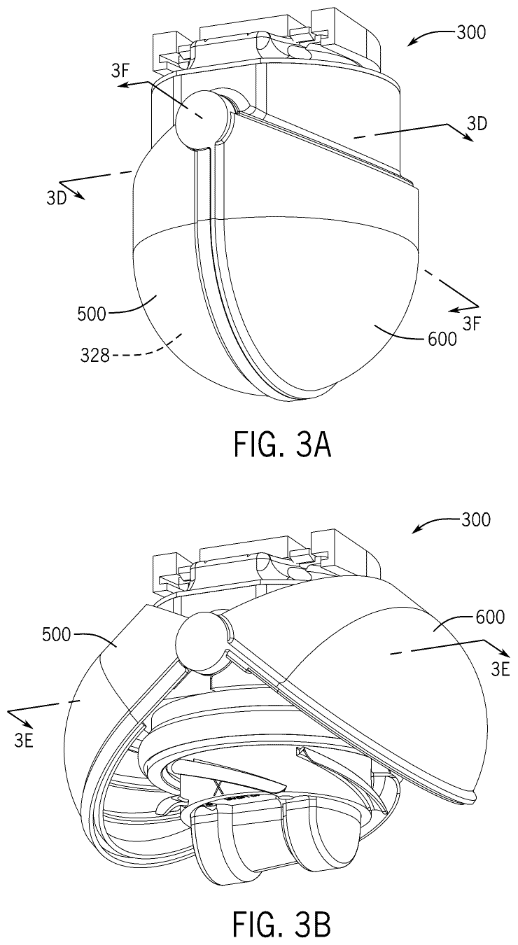

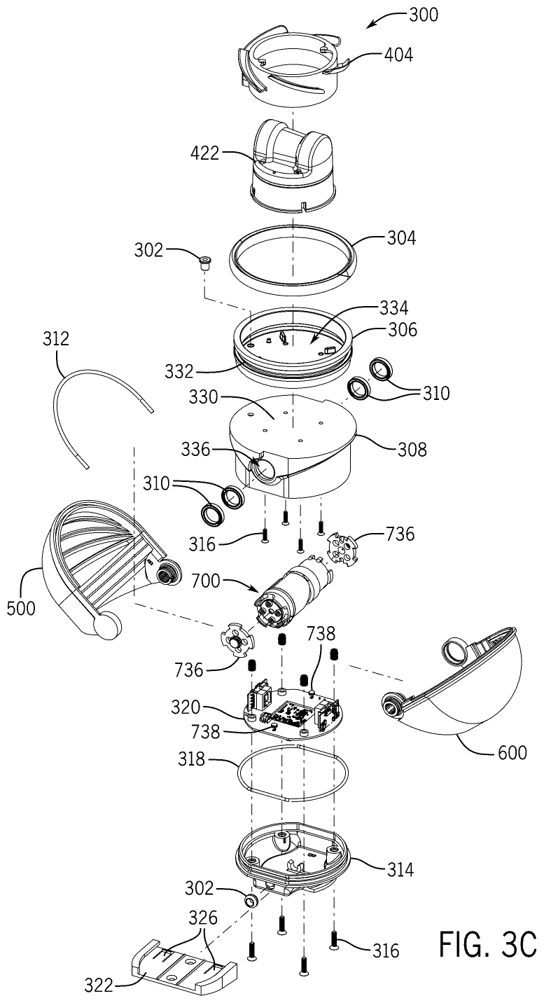

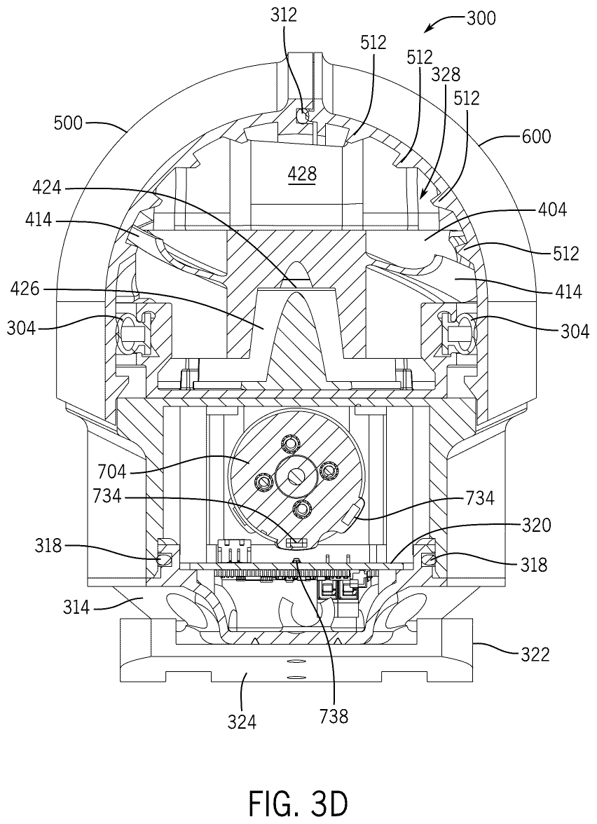

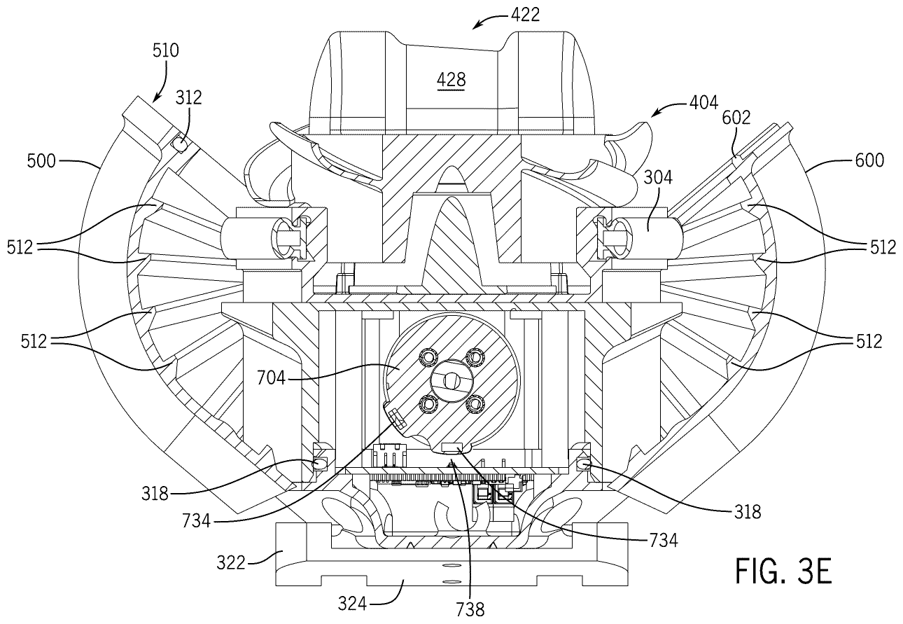

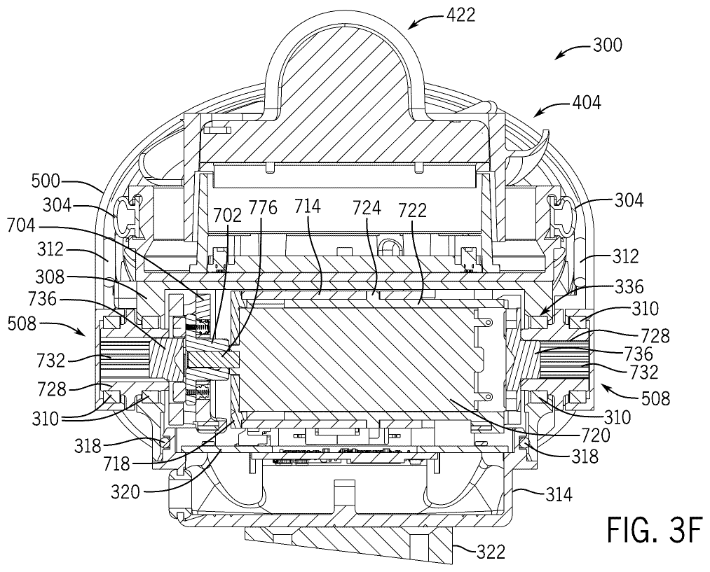

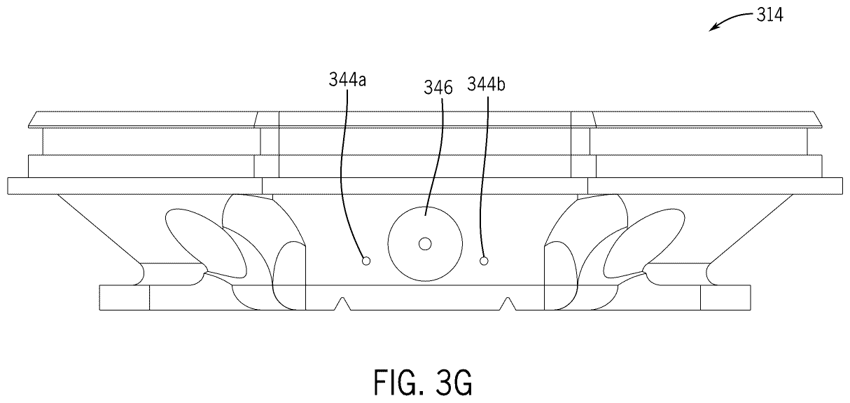

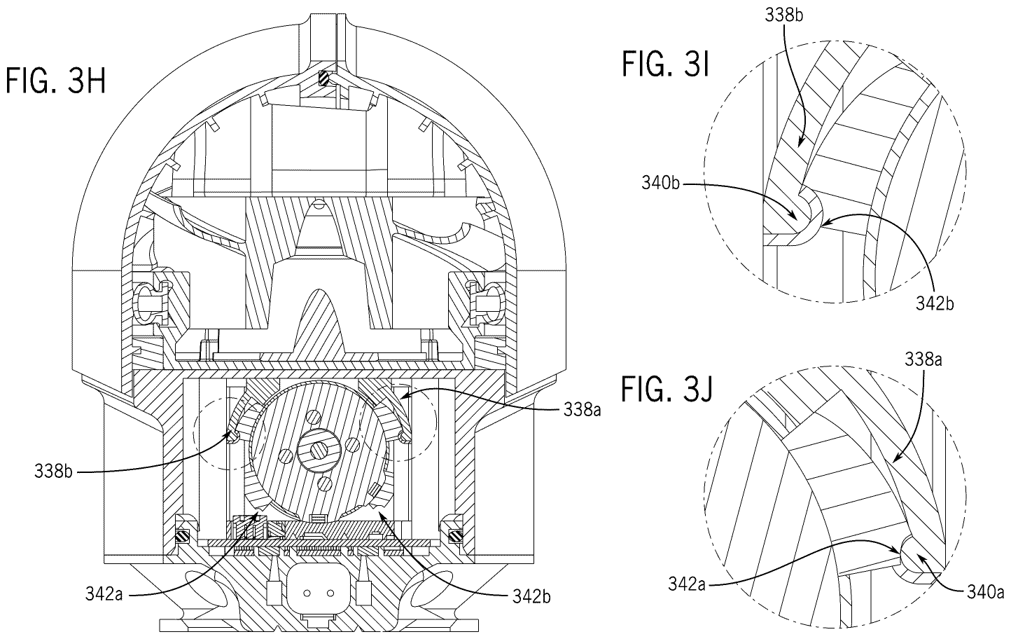

Turning to FIG. 3A-FIG. 8, embodiments of the imaging pod 300 are disclosed. FIG. 3A shows an embodiment of an imaging pod 300 in a first, or closed configuration and FIG. 3B shows the pod in a second, or open, configuration. The imaging pod 300 has a selective opening, e.g., one or two doors (as shown in FIGS. 3A and 3B, a door 500 and a door 600), selectively openable (e.g., by moving the doors from the closed position shown for example in FIG. 3A to the open position shown for example in FIG. 3B). When the doors are in the closed position, the image sensor 422 (see, FIG. 3C) is enclosed in a closed volume 328 formed by the doors. While in the closed volume 328, the image sensor 422 is protected from the environment in the storage location 112, which is often dusty and can be corrosive, and/or otherwise hazardous. When the measurement system 100 takes a measurement of a stockpile 110 with the imaging pod 300, the doors open to reveal the image sensor 422 to the environment and enable the imaging pod 300 to acquire imaging data of the stockpile 110. After the imaging pod 300 acquires the imaging data, the doors will typically close again, once more encapsulating the image sensor 422 within the closed volume 328 formed by the closed doors.

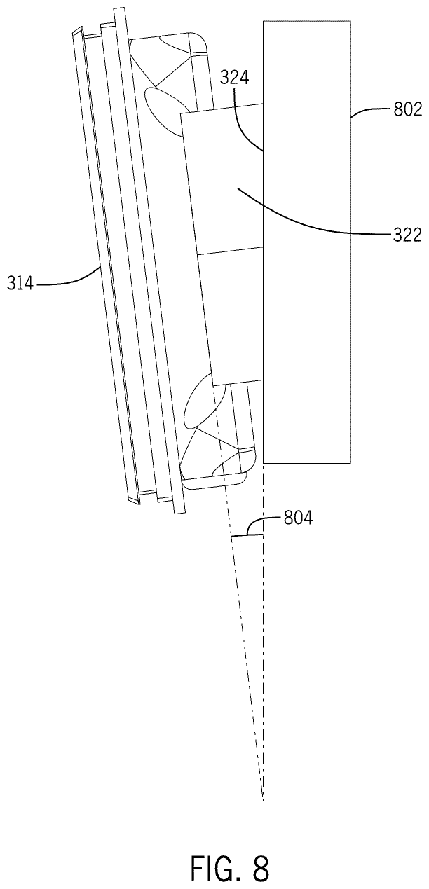

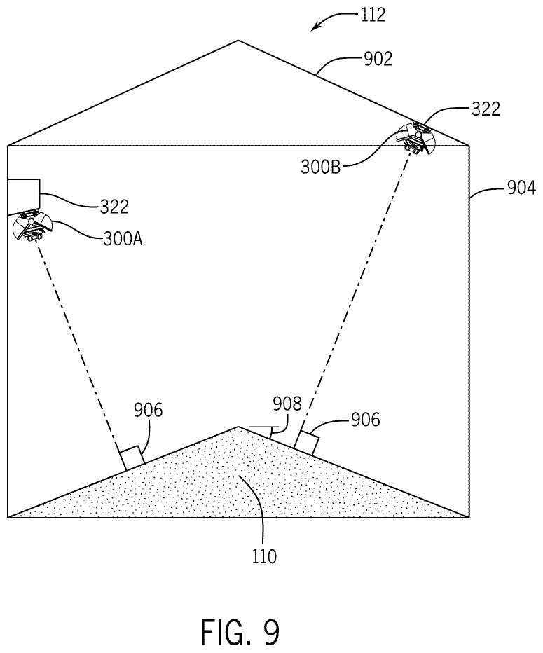

With particular reference to FIG. 3C, an exploded view of an embodiment of the imaging pod 300 is shown. The major components of the imaging pod 300 will be introduced with respect to FIG. 3C and will be described in more detail with respect to later figures. Proceeding from the bottom of FIG. 3C, the imaging pod 300 is mountable to a support surface by a mount 322. As described with respect to FIG. 8 and FIG. 9, a variety of different mounts 322 may be used to adapt the imaging pod 300 to different support surfaces 802, such as walls, posts, joists, beams, ceilings, roofs, etc. The imaging pod 300 is removably couplable to the mount 322 to facilitate easy placement of the mount 322 and/or service of the imaging pod 300 without disturbing the mount 322.

The imaging pod 300 includes a bottom cap 314 removably couple able to the mount 322. The bottom cap 314 includes an aperture therein suitable to receive electrical and/or data cabling. A grommet 302 is receivable in the aperture, to seal the internal compartment of the bottom cap 314 from the environment of the storage location 112. The bottom cap 314 includes a gland, seat, or groove suitable to receive a seal 318 which helps seal a shell 308 to the bottom cap 314 again to prevent or reduce the ingress of contaminants from the environment into the inner portions of the imaging pod 300. In some embodiments, the imaging pod 300 may include a coupling portion configured to receive standard off the shelf connectors, such as Deutsch type sealing connectors that form an electrical connection and seal.

A controller 320 is coupled to the housing and in one example is received in an internal compartment formed by the joining of the bottom cap 314 and the shell 308. The controller 320 is secured to the bottom cap 314 by a plurality of fastener 316, such as nuts, screws, rivets, bolts, snap pins, etc. The controller 320 includes a processing element 1302, I/O interface 1304, a memory component 1308, a network interface 1310, and may optionally include a display 1306 and/or an external device 1312. The controller 320 includes one or more proximity sensors 738 used in the operation of the doors, as described in further detail herein.

In many embodiments, the controller 320 is responsible for the local operation of the imaging pod 300. For example, the controller 320 may receive a command from the measurement system 100 to acquire imaging data of the stockpile 110. The controller 320 may cause the doors of the imaging pod 300 to open, the image sensor 422 to activate, and may record and/or process imaging data. In some embodiments, the controller 320 may also be in communication with the controllers 320 of other imaging pods 300 and may issue commands to the other controllers 320 and/or receive data therefrom.

The doors are operated by a drive assembly such as a drive assembly 700 or a drive assembly 760. While a drive assembly 700 is shown in FIG. 3C, a drive assembly 760 may be used in place of the drive assembly 700 in some embodiments. While the examples of the imaging pod 300 shown include two doors 500 and 600, in some embodiments, a single door may be used and may be moved between open and closed positions by the drive assembly 700 or 760 to reveal or protect the sensor. The drive assembly 700 and drive assembly 760 are coupled to couplers 736 at each end thereof. The couplers 736 interface the door 500 and door 600 to the drive assembly 700 or drive assembly 760, enabling the drive assembly to transmit torque to the door 500 and the door 600 causing the doors to open or close, depending on the direction of the applied torque. The drive assembly 700 or drive assembly 760 are floating in the assembled imaging pod 300. For example, the drive assemblies are coupled to, and supported by, the balance of the imaging pod 300 through the couplers 736. Thus, the drive assembly 700 or drive assembly 760 may rotate within the internal compartment of the imaging pod 300.

The couplers 736 are configured to interface with bearings 310. In many embodiments, an inner bearing 310 rotationally couples the coupler 736 to the shell 308 and an outer bearing 310 rotationally couples the coupler 736 to either of the door 500 or the door 600 (see, e.g., FIG. 3F). The bearings 310 may be any type of bearing, such as a roller bearing, ball bearing, tapered roller bearing, etc. or in some embodiments, the bearings may be bushings 310.

The shell 308 includes main face 330 on an end thereof. The main face 330 is substantially planar and suitable to receive a top cap 306. The top cap 306 includes a gland 332, groove, or receptacle suitable to receive a hollow seal 304. The hollow seal 304 contacts the door 500 and the door 600 when the doors are in the closed position and provides a seal around a perimeter of the top cap 306 for the closed volume 328 that selectively encapsulates the image sensor 422. A seal 312 is couplable to either the door 500 or the door 600 and serves to seal a perimeter of the closed volume 328 when the door 500 and door 600 are in the closed position.

The top cap 306 includes a recess 334 formed by a wall that on an outer side includes the gland 332. The recess has a substantially planar face and is adapted to receive the image sensor 422. An aperture is formed in the planar face of the recess 334 to enable data and/or power cabling (not shown) to pass from the image sensor 422 to the controller 320. The cabling is sealed against infiltration of contaminants by a grommet 302 or other suitable seal such as a lip seal, o-ring, or the like.

In many embodiments, the image sensor 422 is a LIDAR sensor. LIDAR is a remote sensing method that uses light in the form of a pulsed laser to measure ranges (variable distances) to a target surface or object. These light pulses can be used to generate precise, three-dimensional information about the shape and size of an object and its surface characteristics. To scan the target surface, the image sensor 422 rotates about an axis. In some embodiments, the image sensor 422 spins at a speed of about 600 revolutions per minute. An air mover 404, such as a fan, is coupled to the rotating portion (e.g., the lens 428) of the image sensor 422 to cause air movement around the image sensor 422. A benefit of the air mover 404 is that the airflow induced by the spinning thereof automatically cleans the image sensor 422 when the image sensor 422 is activated to acquire image data, blowing dust and debris away from the image sensor 422. Thus, the imaging pod 300 is self-cleaning and can accurately acquire measurements of the stockpile 110 in harsh, dusty environments.

Turning to FIG. 3D and FIG. 3E, the operation of the doors (e.g., the door 600 and the door 500) is shown in more detail. The doors 500 and 600 are coupled to a drive assembly 700 that selectively opens the doors (as shown for example in FIG. 3E) to enable the imaging pod 300 to acquire image data of the stockpile 110. The drive unit selectively closes the doors 500 and 600 (as shown for example in FIG. 3D) to protect the image sensor 422 of the imaging pod 300 from the environment in the storage location 112.

FIG. 3D and FIG. 3E are section views of the imaging pod 300 taken through line 3D-3D and 3E-3E of FIG. 3A through a receiver 704 that interfaces the coupler 736 to the motor 720 of the drive assembly 700 or the drive assembly 760.

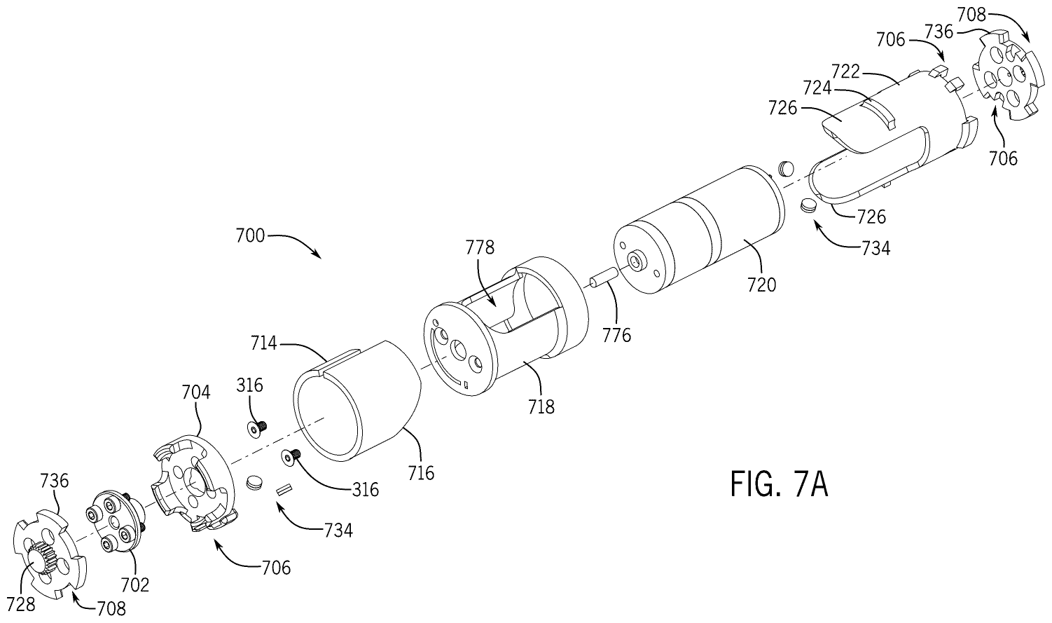

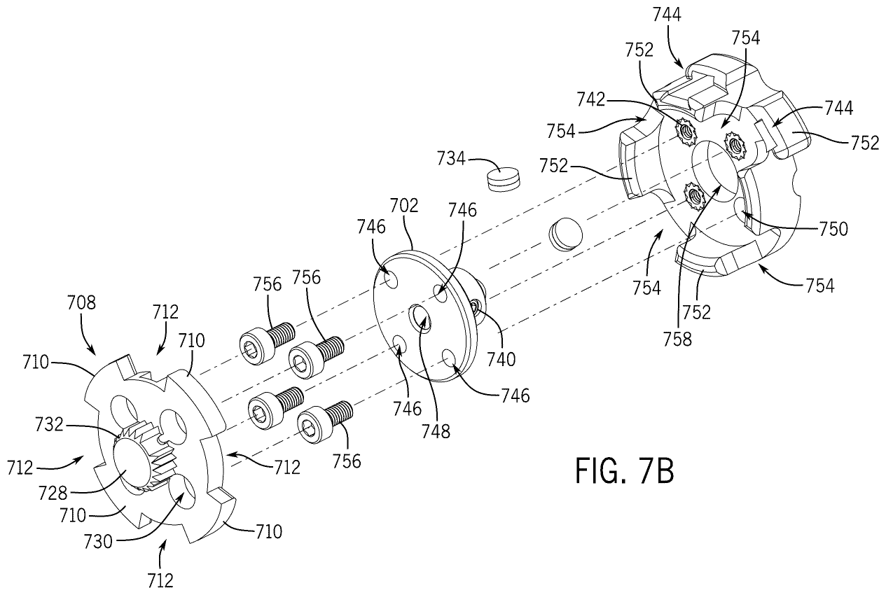

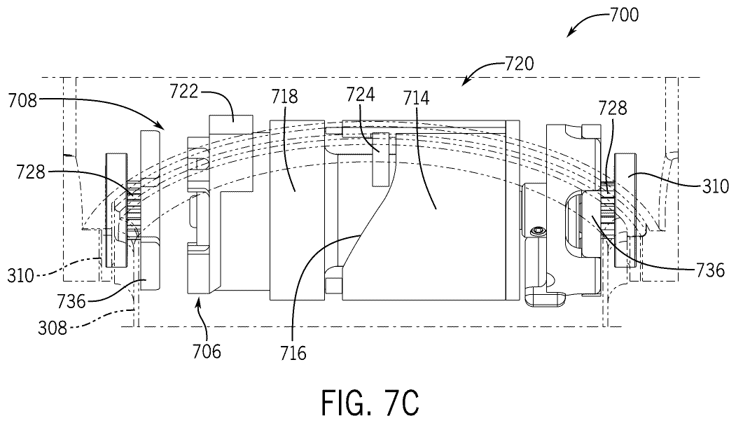

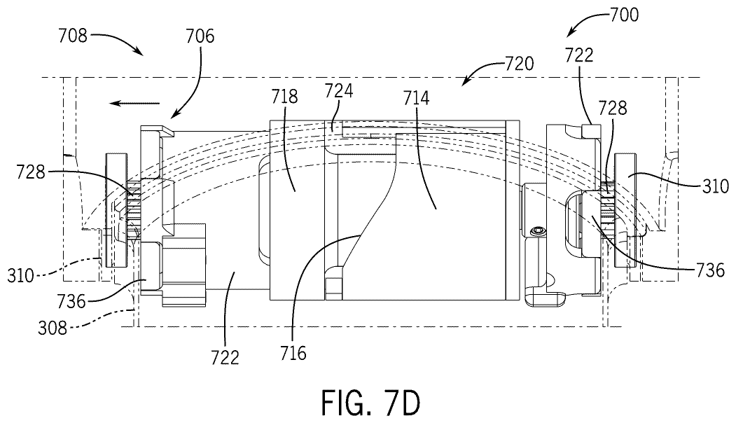

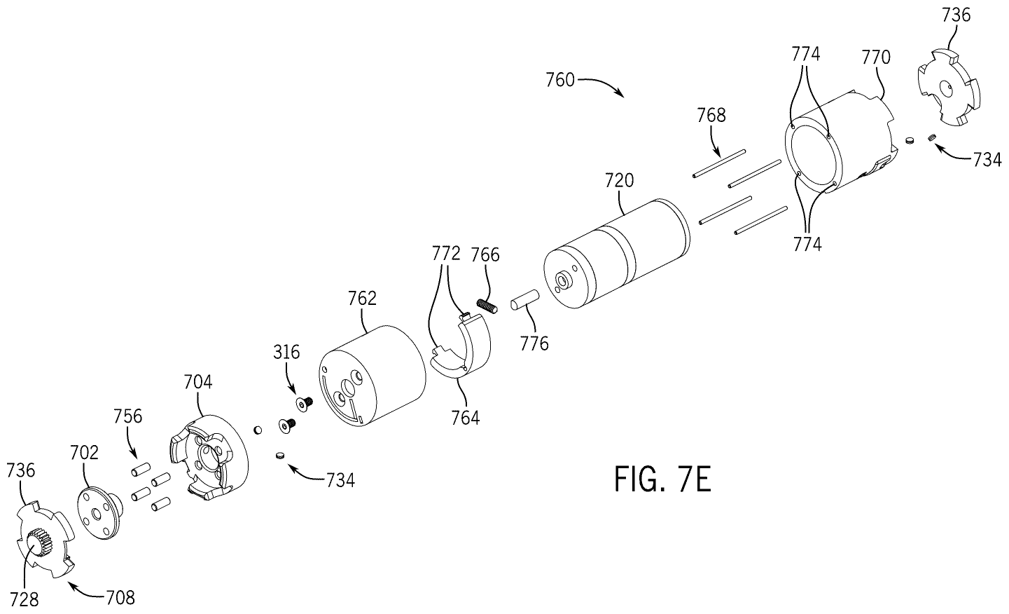

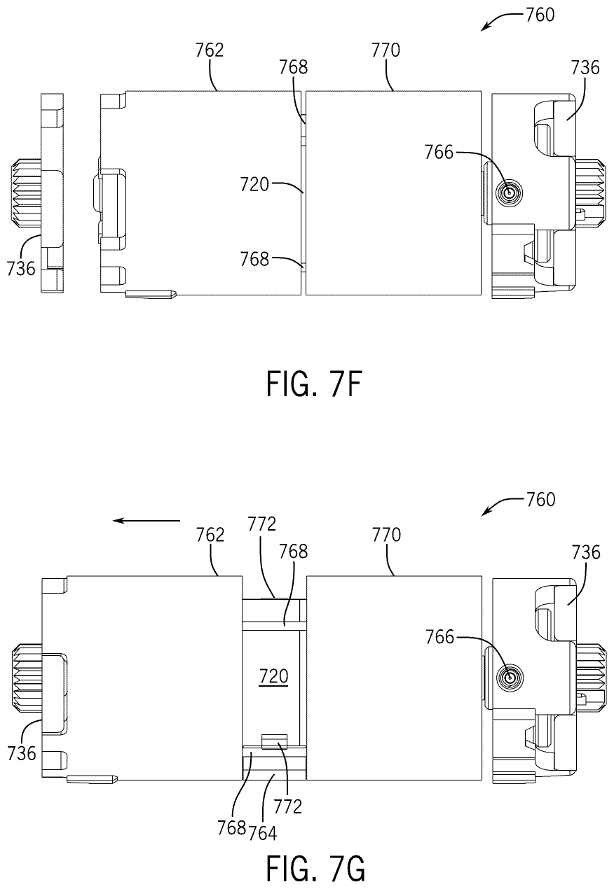

The receiver 704 is adapted to couple to both the motor 720 and to the coupler 736 (as shown and described in more detail with respect to FIG. 7A-FIG. 7G. The receiver 704 includes features to enable the coupling or embedding of one or more magnetic elements 734 thereto. The controller 320 includes one or more proximity sensors 738 activated in the proximity of a magnetic element 734. When the doors are in the closed position (e.g., as shown in FIG. 3D), one of the magnetic elements 734 is disposed close to (e.g., above) a respective one of the proximity sensors 738. When the doors are in the closed position, the controller 320 registers the doors as being closed based on the activation of the proximity sensor 738 by the magnetic element 734.

Similarly, as shown for example in FIG. 3E, when the doors are in the open position, another of the magnetic elements 734 is in a position close to the proximity sensor 738 and activates the proximity sensor 738 to indicate to the controller 320 that the doors 500 are open. The magnetic elements 734 and proximity sensor 738 provide the controller 320 with data regarding the open or closed (or in-between) status of the doors 500. The controller 320 may take appropriate action based on the signals from the proximity sensor 738 to move the doors to a desired position, as discussed further with respect to the operation 1016 of the method 1000. The structure and the function of the end of the drive assembly 700 or drive assembly 760 opposite the end shown in FIG. 3D and FIG. 3E is substantially similar to that shown in FIG. 3D and FIG. 3E.

In some embodiments, the controller 320 includes a motor sensor configured to measure an amount of effort exerted by the motor 720. For example, the motor sensor may be a current sensor such as a hall effect current sensor or a shunt and differential voltage measurement circuit, or the like. The controller 320 determines a baseline current drawn by the motor 720 during normal operation of the doors. For example, the controller 320 may perform a calibration when the pod 300 is initially installed and the doors are clean and operating normally (e.g., the doors open and close freely without binding or obstruction). This baseline current may be determined for and/or by each imaging pod 300 or may be a typical value or range of values for imaging pods 300. The baseline current may be stored in the memory component 1308 of the imaging pods 300 or another device such as the server. When the motor 720 is operated, the motor current may rise or spike above the baseline level when a door reaches an obstruction (e.g., the fully open or closed position or debris or other contamination). The controller 320 may detect this rise in motor current and may use the elevated current in conjunction with one or more proximity sensors to indicate the extent of the position of the doors 500 and 600. Additionally, or alternately, the controller 320 may detect abnormal voltage readings indicative of a stuck or difficulty-to-open door. In some embodiments, the image sensor 422 may be used to detect a stuck door. For example, the image sensor 422 may send light pulses that reflect off the closed/stuck doors and the controller 320 or the sensor 422 can detect that the object detected by the sensor is too close to the imaging pod to be a stockpile or other feature and is thus a portion of the imaging pod 300 being detected (e.g., a closed door 500/600). In some embodiments, the sensor 422 will confirm the doors 500/600 are open before a scan of a stockpile 110 starts. In some embodiments, the sensor 422 will confirm the doors 500/600 are fully closed after a scan of a stockpile 110.

In some embodiments, such as those including two or more doors, there may be a motor 720 for each door. For example, a first motor may be configured to drive the first door and a second motor may be configured to drive a second door. This may allow the doors to be opened at different instances and/or speeds, but may require a larger or elongated base to house the additional motor.

As described above with respect to the closed volume 328, the seal 318, hollow seal 304, and the seal 312 cooperate to reduce or prevent the ingress of dust, debris, and other environmental contaminants into the closed volume 328. As shown for example in FIG. 3D, the image sensor 422, and the air mover 404 are encapsulated within the closed volume 328 when the doors 500 and 600 are in the closed position. The hollow seal 304 may be particularly configured to form a seal with the inner surfaces of the doors 500 and 600 without imparting a large force to the doors. For example, the hollow structure of the hollow seal 304 enables the hollow seal 304 to compress slightly under the imparted force of the door 500 and door 600, without needing a high torque input from the motor 720. Aspects of the sealing system of the closed volume 328 are also shown in FIG. 3F.

FIG. 3F is a section view of the imaging pod 300 through the rotational axis of the drive assembly. In FIG. 3F, a drive assembly 700 is shown, but a drive assembly 760 may be used instead of a drive assembly 700. In FIG. 3F, the doors 500 and 600 are shown in the open position. FIG. 3F illustrates the floating structure of the drive assembly 700 or drive assembly 760 in the imaging pod 300.

For example, in the drive assembly 700 or the drive assembly 760, the ends of the drive assembly are rotatably coupled to the doors 500 and door 600. In some embodiments, each end of a drive assembly 700 or drive assembly 760 is coupled to each of the doors 500 and 600. For example, with reference to the left portion of FIG. 3F, and also to the exploded views of the drive assembly 700 in FIG. 7A and drive assembly 760 in FIG. 7E, respectively, the left end of the drive assembly 700 shown in FIG. 3F is coupled to both of the doors 500 and 600. Similarly, the right end of the drive assembly 700 is coupled to both of the door 500 and 600. For example, the drive assembly 700 includes a motor 720 that receives a drive shaft 776 in an end thereof. The shaft 776 is keyed or coupled to a hub 702 and to a receiver 704 (e.g., with a set screw 766 as shown in FIG. 7F). The set screw 766 may be a point-tip, cupped tip, conical and/or serrated-tipped set screw, as desired. The hub 702 is coupled to the receiver 704 by one or more fasteners threadedly received in inserts themselves received in apertures formed in the receiver 704 (see, e.g., FIG. 7B). In many embodiments, the hub 702, receiver 704, and shaft 776 all rotate together.

As shown for example on the left side of FIG. 3F, the receiver 704 includes a castellated portion 706 that receives a flanged portion 708 of the coupler 736. Similarly, As shown for example in the right side of FIG. 3F, the motor 720 is received in a distal sleeve 722 (see FIG. 7A for additional description) including a castellated portion 706 that engages with the coupler 736 near a distal end of the drive assembly 700. Thus, in many embodiments, the coupler 736 also rotates in unison with the hub 702, the receiver 704 and the shaft 776. The coupler 736 includes a raised spline 728 including a plurality of spline teeth 732 on an outer surface thereof.

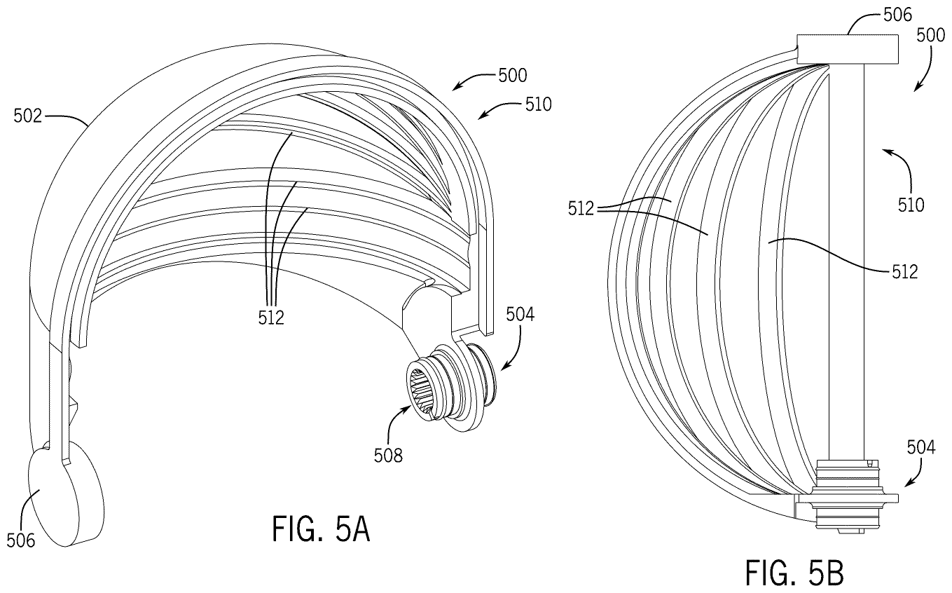

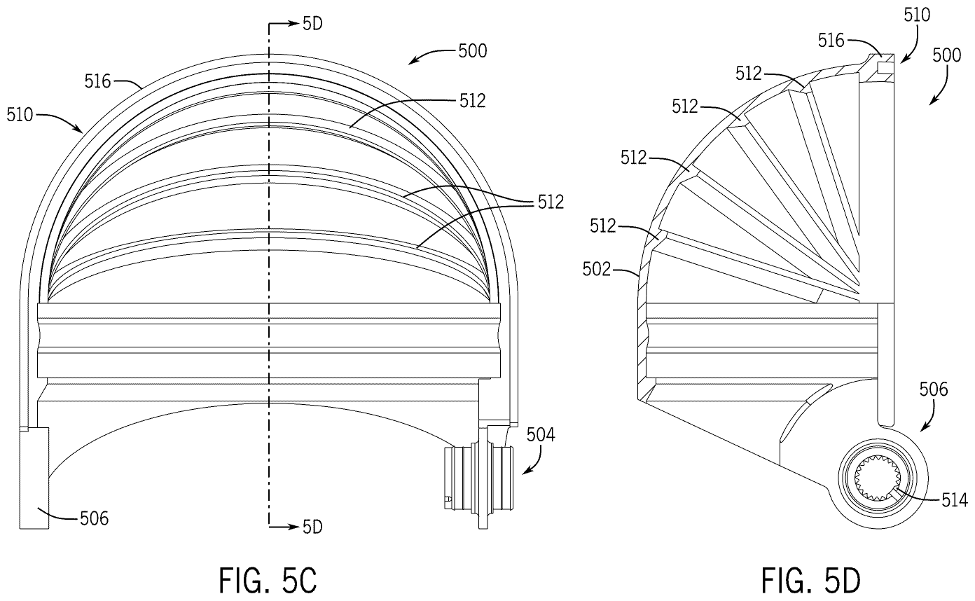

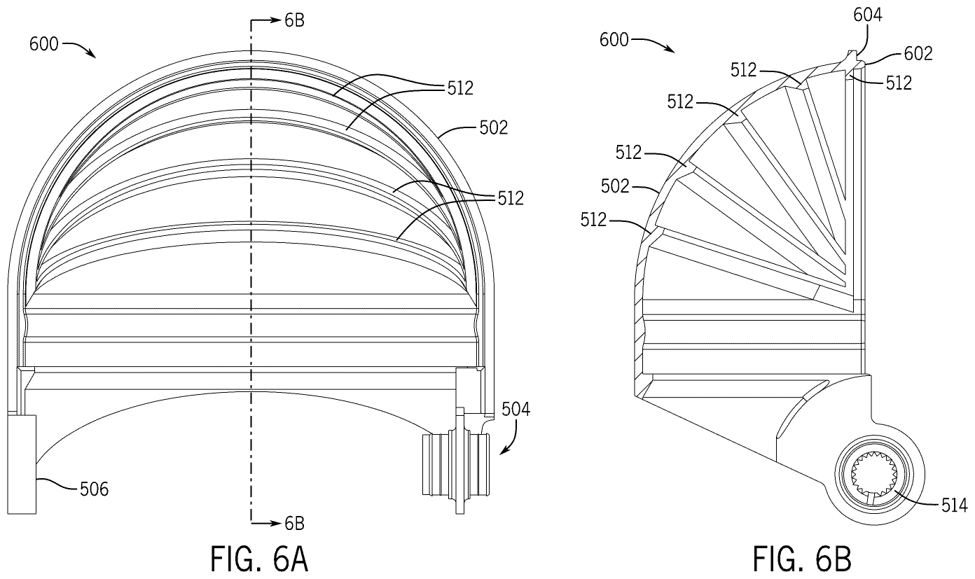

Turning momentarily to FIG. 5A-FIG. 6B, each of the doors 500 and 600 includes a follower hub 506 and a driven hub 504. The driven hub 504 includes a receiver 508, for example an internally splined aperture with receiver teeth 514 on an inner surface thereof. In many embodiments, the door 500 and the door 600 include the follower hub 506 and the driven hub 504 on the same portions of the respective doors 500 and 600 such that when the doors are placed in the assembled imaging pod 300 in a facing relationship, the follower hub 506 of the door 500 receives the driven hub 504 of the door 600. Likewise, the follower hub 506 of the door 600 receives the driven hub 504 of the door 500.

Returning to FIG. 3F, the receiver 508 of the door 600 receives the spline 728 of the coupler 736. In many embodiments, the spline 728 rotationally locks the receiver 508 and the driven hub 504 to the hub 702, receiver 704, and shaft 776. The driven hub 504 of each door 500 and door 600 is rotationally coupled to the shell 308 by the inboard bearing 310 of each respective pair of bearings 310. For example, an outer race of the inboard bearing 310 is received in the apertures 336 of the shell 308. The inner race of the inboard bearing 310 is received on an outer surface of the driven hub 504, thus enabling the respective driven hubs of the door 500 and the door 600 to rotate with respect to the shell 308. The driven hub 504 of each of the doors 500 and door 600 is rotationally coupled to the follower hub 506 of the other of the door 500 and door 600 via the outboard bearing 310 of each respective pair of bearings. For example, the inner race of the outboard bearings 310 are received on an outer surface of the driven hub 504 of one of the door 500 or 600 (spaced laterally from the surface that receives the inner race of the inboard bearings 310). The outer race of the outboard bearing is received in the follower hub 506 of the other of the door 500 or the door 600.

The structure of the doors 500 and 600 and drive assemblies 700 and 760 as described above has a number of advantages. For example, the drive assembly is allowed to rotationally float within the imaging pod 300 such that the drive assembly 700 or 760 and the doors 500 and doors 600 can find their own equilibrium positions as torque is applied by the motor 720. For example, while the rotational motion of the shaft 776 may cause the driven hub 504 of the door 600 to turn, the reaction torque to that turning may cause the motor 720 (and the distal sleeve 722) to turn in an opposite direction to drive the driven hub 504 of the door 500. This effect can help reduce excess stressed on the doors and drive assembly, especially when contaminated with dust, dirt, or other contaminates from the environment in the storage location 112. In effect, when the doors open or close, one door may move slightly, until resistance to rotation of that door becomes greater than in another portion of the drive assembly and then another door may move while the first door pauses. In other cases, the doors may move simultaneously and at the same or different speeds. Furthermore, the described structure removes the need for hard mechanical stops for the doors, which can become encrusted with contamination and then cause the doors to fail to open or close completely.

FIGS. 3H-3J show an alternate embodiment of portions of the shell 308 including a plurality of resilient arms 338a and 338b extending from an inner surface thereof. The resilient arms 338a and 338b each include respective protrusions 340a/340b at an end thereof distal from the inner surface of the shell 308 from which the arms 338a and 338b extend. In this embodiment, the couplers 736, the distal sleeve 722, and/or the distal sleeve 770 include respective recesses 342a and 342b (e.g., formed in the flanges 710 of the couplers 736) that selectively receive the respective protrusions 340a/340b.

As shown in FIGS. 3I and 3J, the protrusions 340a and 340b may be different sizes compared to one another. For example, as shown in FIG. 3J, the protrusion 340a is larger (e.g., protrudes laterally from its respective arm 338a) than the protrusion 340b. In some embodiments, the resilient arms 338a and 338b may have different stiffnesses or strengths with respect to one another. The engagement of the differently sized protrusions 340a/b with the respective recesses 342a/b causes one of the doors to preferentially open and close before the other door. For example, the door 600 may open before the door 500 opens. Similarly, the door 600 may close before the door 500 closes. In other embodiments, the door 500 may open before the door 600, and the door 500 may close before the door 600. These features can provide for additional troubleshooting and diagnosis of the operation of the imaging pod 300, especially when combined with the magnetic elements 734 and proximity sensors 738, e.g., by making the opening order of the doors 500 and 600 consistent and predictable.

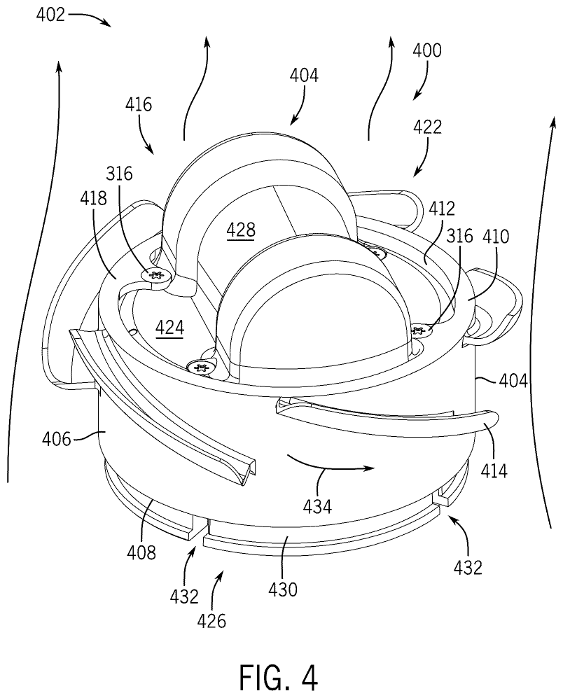

Turning to FIG. 4, an embodiment of a sensor/fan assembly 400 is shown. The sensor/fan assembly 400 comprises an air mover 404 and an image sensor 422. As discussed, the image sensor 422 is a LIDAR sensor in many embodiments. In other embodiments, the image sensor 422 may use other types of imaging technology such as optical, infrared, ultraviolet, or microwave or millimeter wave sensing technology, photogrammetry, etc. The image sensor 422 shown has a stationary hub 426 and a rotor 424. The hub 426 includes an attachment 432 at an end thereof and adapted to couple the image sensor 422 to the main face 330 of the shell 308 such as by one or more fasteners. The rotor 424 includes an emitter (e.g., a laser emitter) and a detector suitable to receive reflected laser light emitted by the emitter. The emitter and/or detector are shielded by a lens 428. The 424 rotates with respect to the hub 408 such that the emitter can scan the target surface of the stockpile 110.

In many embodiments, the air mover 404 is a fan, although other types of air movers may be used (e.g., a blower). The air mover 404 includes a main body 406 with a collar 410 that forms a main aperture 416 through the main body 406. The collar 410 includes a plurality of flanges 418 extending into the main aperture 416 at an end portion of the main body 406. The flanges 418 include apertures adapted to receive fasteners 316 that couple the air mover 404 to the rotor 424 of the image sensor 422. The inner surface 412 of the main aperture 416 is shaped such that the outer surface of the rotor contacts the inner surface of the main aperture 416 but provides a clearance with the outer surface 430 of the hub 408. Thus, the air mover 404 is sized to prevent contact with the stationary hub 408. For example, the main aperture 416 may be stepped or tapered or otherwise have more than one inner diameter. One or more blades 414 extend radially from the outer surface of the collar 410.

When the image sensor 422 is actively acquiring image data, the rotor spins (e.g., at 600 rpm, but may spin at higher or lower speeds). For example, the rotor 424 may spin in the direction 434. The spinning causes the blades 414 to induce an airflow 402 about the image sensor 422. The airflow cleans debris, particles, and other contaminants from the image sensor 422, thereby providing the surprising benefit of enabling the imaging pod 300 to be self-cleaning.

In some embodiments, the fan 404 may be asymmetrical (either gravimetrically or volumetrically) with respect to an axis of rotation of the fan 404 and/or the sensor 422 for example to counterbalance the sensor 422. For example, the sensor 422 may include a mirror or other rotating mass that produces harmonic vibrations at certain rotational speeds. The fan 404 may include a counterbalance 436 weight or feature that counterbalance the mass in the sensor 422 to reduce vibrations at certain frequencies. In some embodiments, the fan 404 may include a counterbalance 436 feature 3D printed into, or integrally formed with, the fan 404. Additionally, or alternately, the fan 404 may include one or more apertures (e.g., blind holes or pockets) configured to receive a counterbalance 436 weight. For example, a weighted item such as a metal (e.g., lead, steel, etc.) weight may be received in the aperture, such that the counterbalance 436 weight counteracts weight eccentricities within the sensor 422 at various rotational speeds. In some examples the counterbalance 436 weight is a feature formed on the collar 410, perimeter, or elsewhere on the main body 406 of the fan 404. The counterbalance 436 weight is typically less than a gram to several grams in weight (e.g., 0.5 or less or, 1, 2, 3, 4, 5, 6, 7, 8, 9, 10 grams or more.)

Turning to FIG. 5A-FIG. 6B, the door 500 and the door 600 are shown in further detail. The doors 500 and 600 each include a shroud 502. In many embodiments, the shroud 502 of the door 500 is a substantially hemi-spherical shell adapted to cooperate with the shroud 502 of the door 600 to form a closed volume 328 around the image sensor 422 of the imaging pod 300. In other embodiments, the shrouds 502 may have other shapes than substantially hemispherical, such as cubical, prismatic, or irregular shapes.

The shrouds 502 include ribs 512 disposed on an inner surface thereof. The ribs 512 may provide rigidity or strength to the shrouds 502. As described herein, the door 500 and the door 600 each include respective driven hubs 504 and follower hubs 506 about which the doors are adapted to pivot (e.g., between open and closed positions). The edge portion of the door 500 includes a flange 516 that forms a gland 510 suitable to receive the seal 312. For example, the gland 510 may be a thin, curved recess formed in the door 500 of a suitable width to receive the seal 312. In some embodiments, the width of the gland may be slightly smaller than an uncompressed dimension of the seal 312, such that the seal 312 is press-fit within the gland 332. Thus, the seal 312 may be received in the gland 510 with or without the use of adhesives. The door 600 is similar to the door 500 in many respects, but instead of a gland at an edge portion of the shroud 502, the door 600 includes a flange 604 extending radially from the hubs of the door 600 and a lip 602 extending circumferentially. The lip 602 is a thin, curved protrusion that rises proud of the shroud 502 and is adapted to engage the seal 312 received in the gland 510 when the doors 500 and 600 are in the closed position, e.g., as shown for example in FIG. 3D. Similarly, the flange 516 and the flange 604 cooperate to further seal the closed volume 328 when the doors 500 and door 600 are closed.

Turning to FIG. 7A, the drive assembly 700 is shown in detail. The drive assembly 700 is selectively collapsible, such as to facilitate installation of the drive assembly 700 in the imaging pod 300. The drive assembly 700 includes a hub motor 720, such as a brushed or brushless AC or DC motor. The motor 720 includes electrical leads (not shown) that couple the motor 720 to a power source in communication with the controller 320. The controller 320 can cause the motor 720 to rotate in either a clockwise or counterclockwise direction, as desired.

Surrounding respective portions of the motor 720 is a medial sleeve 718 and a distal sleeve 722. In many embodiments, the distal sleeve 722 has a thin main body with a base. A central aperture is formed in the main body. The distal sleeve 722 includes a castellated portion 706 at one end of the main body that couples with a distal coupler 736 (e.g., with the flanged portion 708 of the distal coupler 736), as described with respect to FIG. 3F. The distal sleeve 722 includes two opposing biasing elements 726 extending longitudinally from the base of the distal sleeve 722. Each of the biasing elements 726 includes a tang 724 protruding radially from the biasing element 726. The central aperture is adapted to receive a portion of the motor 720.

The drive assembly 700 includes a proximal sleeve 714. The proximal sleeve 714 has a thin main body with a cam surface 716 formed on an edge thereof. The proximal sleeve 714 includes a central aperture.

The medial sleeve 718 has a thin main body with two receptacles 778 formed therein and in communication with a central aperture. The central aperture is adapted to receive a portion of the motor 720. The receptacles 778 are adapted to receive portions of the biasing elements 726 of the distal sleeve 722 and also the proximal sleeve 714.

With reference to FIG. 3A, when the proximal sleeve 714, medial sleeve 718, and distal sleeve 722 are assembled with the motor 720, the motor 720 is received in the central aperture of the distal sleeve 722. At least a portion of the distal sleeve 722 is received in the central aperture of the proximal sleeve 714. The biasing elements 726 and the tang 724 of the distal sleeve 722 are received in the receptacles 778 of the medial sleeve 718. For example, the biasing elements 726 may be flexed inward such that the tangs 724 can be inserted into the central aperture of the medial sleeve 718. The tangs 724 are secured between the body of the proximal sleeve 714 and the body of the medial sleeve 718.

With reference to FIG. 7B, details of portions of the drive assembly 700 and the drive assembly 760, specifically the hub 702, the receiver 704, and the coupler 736 are shown.

The receiver 704, couples to the shaft 776 of the motor 720 and interfaces with the coupler 736 to transmit torque and rotary motion from the motor 720 to the doors 500 and 600. The receiver 704 includes a disc-shaped main body with a central aperture 758 formed therethrough. Radially spaced from the central aperture 758 and arrayed around the central aperture 758, the receiver 704 includes a plurality of apertures 750. The apertures 750 are typically smaller in diameter than the central aperture 758. The apertures 750 may be configured to receive respective threaded inserts 742 that bite or grab into the main body in the aperture 750 and provide a threaded interface suitable to receive respective fastener (cap screw or dowel) 756, such as screws or bolts. In some embodiments, such as the drive assembly 760, the fasteners 756 are dowels or roll pins received in the apertures 750 such as by interference or press fit.

The receiver 704 includes a castellated portion 706 protruding from the main body. The castellated portion 706 is formed of alternating parapets 752 and embrasures 754. The receiver 704 includes provisions for receiving one or more magnetic elements 734. For example, one or more of the parapets 752 may include a receptacle 744 suitable to receive a magnetic element 734. The receptacle 744 may be in the form of blind or through slots sized such that a magnetic element 734 may be received therein, such as by a press fit, to prevent or reduce movement of the magnetic element 734. In some embodiments, the magnetic element 734 may be coupled to the receptacle 744 with a fastener, adhesive, etc.

Turning to the hub 702, the hub 702 includes a disc-like main body with a post rising therefrom. The hub 702 includes a disc-shaped main body with a central aperture 748 formed therethrough. Radially spaced from the central aperture 748 and arrayed around the central aperture 748, the hub 702 includes a plurality of apertures 746. The apertures 746 are typically smaller in diameter than the central aperture 748. The post receives a set screw 740 in a radial direction.

Turning to the coupler 736, the coupler 736 includes a disc-shaped main body with a spline 728 protruding longitudinally therefrom. The spline 728 includes a plurality of spline teeth 732 on an outer surface thereof. The main body includes a plurality of apertures 730 arrayed around the spline 728. The coupler 736 includes a flanged portion 708 extending radially from the main body. The flanged portion 708 includes a plurality of alternating flanges 710 and recesses 712.

To assemble the hub 702, the receiver 704, and the coupler 736 with the balance of the drive assembly 700 of drive assembly 760, the threaded inserts 742, if used, are inserted into the apertures 750. The receiver 704 is fitted over the shaft 776 through the central aperture 758. The hub 702 is inserted into the central aperture 758 with the shaft 776 received in the central aperture 748 of the hub 702. The fasteners 756, if used (e.g., in the drive assembly 700) are inserted through the apertures 746 and threaded to the threaded inserts 742 received in the apertures 750. If the fasteners 756 are dowels or roll pins, these are inserted through the apertures 746 and pressed into the apertures 750.

The spline 728 of the coupler 736 is inserted into the receiver 508 on the respective door 500 or door 600, with the spline teeth 732 meshing with the receiver teeth 514.

In some embodiments, the imaging pod 300 may also include one or more user outputs, such as lights, a display, or the like, to provide output to a user regarding a state or status of the pod 300. In one example, as shown in FIG. 3G, the imaging pod 300 may include two more lights (e.g., light emitting diodes 344a and 344b or light pipes that extend through a wall of the bottom cap 314) that may be coupled to the circuit board and one or more light pipes or other light transmitting device port the light from the interior of the pod to an aperture or other transmissive area of the housing to be visible to the user. The light or lights 344a/b then are actuated in different colors or sequences to indicate the status (e.g., powered on, powered off, open, fault, normal operation, etc.) of the imaging pod 300.

With reference to FIG. 7C and FIG. 7D, an example of a process of installing the drive assembly 700 in the imaging pod 300 is shown. A similar process for the drive assembly 760 is shown in FIG. 7F and FIG. 7G. Both the drive assembly 700 and the drive assembly 760 are selectively collapsible, such as to facilitate installation of the drive assembly 700 or drive assembly 760 in the imaging pod 300. For example, the drive assemblies drive 700 and 760 are configurable between a collapsed configuration and an extended configuration. In FIG. 7C, the drive assembly 700 is shown in a collapsed configuration. In FIG. 7D, the drive assembly 700 is shown in an extended, installed position in the imaging pod 300. In FIG. 7F the drive assembly 760 is shown in a collapsed state and in FIG. 7G the drive assembly 760 is shown in an extended state.

To install the drive assembly 700 in the imaging pod 300, the drive assembly 700 is inserted into the shell 308 with the follower hub 506 and the driven hub 504 of the door 500 and door 600 aligned with each other and with the apertures 336 of the shell 308. The collapsed drive assembly 700 (e.g., in the configuration shown in FIG. 7C) is inserted into the shell 308. The medial sleeve 718 is twisted with respect to the proximal sleeve 714 which causes the tang 724 to ride along the cam surface 716. The sloped surface of the cam surface 716 causes the medial sleeve 718 to move longitudinally along the motor 720 body lengthening the drive assembly 700. As the medial sleeve 718 extends, the medial sleeve 718 moves the receiver 704 and hub 702 longitudinally until the castellated portion 706 of the receiver 704 engages with the flanged portion 708 of one of the couplers 736 and the castellated portion 706 of the distal sleeve 722 engages with the other coupler 736 at the opposite end of the drive assembly 700. The set screw 740 in the hub 408 is tightened against a flat or boss on the shaft 776.

With reference to FIG. 7E, the drive assembly 760 includes many similar elements as the drive assembly 700 such as the receiver 704, hub 702, couplers 736, magnetic elements 734, and shaft 776. The drive assembly 760 includes a distal sleeve 770 including a castellated portion 706 suitable to engage with the flanged portion 708 of the coupler 736. The distal sleeve 770 includes a plurality of apertures 774 suitable to receive respective resilient pins 768. The drive assembly 760 includes a medial sleeve 762 also including apertures 774 suitable to receive ends of the resilient pins 768 opposite the ends thereof received in the apertures 774 of the distal sleeve 770. The medial sleeve 762 is secured to the motor 720 via one or more fasteners 316. The drive assembly 760 includes a collar 764 with an arcuate body including respective tangs 772 at opposite ends thereof.

To install the drive assembly 760 with the imaging pod 300, the doors 500 and 600 and couplers 736 are arranged as described with respect to the drive assembly 700 and FIG. 7C and FIG. 7D. The medial sleeve 762 is coupled to the motor 720 with the fasteners 316. The resilient pins 768 are inserted into the apertures 774 in either the distal sleeve 770 or the medial sleeve 762. The distal sleeve 770 and medial sleeve 762 are slid over the motor 720 with the resilient pins 768 being received in the apertures 774 in both the medial sleeve 762 and distal sleeve 770. The collar 764 is temporarily omitted, as shown for example in FIG. 7F. The partially assembled drive assembly 760 is inserted into the shell 308. The distal sleeve 770 and medial sleeve 762 are slid away from one another along the longitudinal axis of the motor 720 until the castellated portion 706 of the distal sleeve 770 and the drive assembly 760 of the receiver 704 mesh with the receiver 508 as described with respect to the drive assembly 700. The collar 764 is installed into the gap between the medial sleeve 762 and distal sleeve 770. The tangs 772 are clipped under respective resilient pins 768 to secure the collar 764 to the balance of the drive assembly 760. The set screw 740 in the hub 408 may be tightened against a flat or boss on the shaft 776 either after installation of the collar 764 or after engaging the castellated portions 706 with the couplers 736.

The drive assembly 700 and the drive assembly 760 provide surprising benefits of enabling easy installation to the imaging pod 300 by being configurable between collapsed and extended configurations.

FIG. 8 shows an embodiment of a mount 322 for use with an imaging pod 300. The mount 322 is adapted to be coupled to a support surface 802 such as a wall, ceiling, beam, girder, rafter, roof, floor, etc. of a storage location 112. The mount 322 includes a receptacle to receive the bottom cap 314 of the imaging pod 300. In some embodiments, fasteners such as screws, bolts, nuts, etc. may be used to couple the imaging pod 300 to the mount 322. In many embodiments, the bottom cap 314 can be removably coupled to the mount 322 without tools, such as by a snap or click fit via the biased retainers 326 (sec, e.g., FIG. 3C) for easy removal, installation, and/or maintenance of the imaging pod 300. Thus, the mount 322 can be coupled to the support surface 802 and the imaging pod 300 coupled to the mount 322.

With reference to FIG. 8 and FIG. 9, the mount 322 includes a mounting face 324 forming an angle 804 with respect to the support surface 802. The angle 804 may be adapted to position the imaging pod 300 relative to either or both of the support surface 802 or a stockpile 110. As shown for example in FIG. 9, a mount 322 may be adapted to couple an imaging pod 300A to a wall 904. The mount may also be adapted to aim or position the imaging pod 300 with respect to the stockpile 110. For example, the material forming the stockpile 110 may have an angle of repose 908 and the mount 322 may position the imaging pod 300A to achieve a desired incident angle 906 with respect to a surface of the measurement system 100 based on the angle of repose 908. In another example, a mount 322 may be adapted to couple an imaging pod 300B to a ceiling 902 of the storage location 112. Similarly, the mount 322 to which the imaging pod 300A is coupled positions the imaging pod 300B with respect to the stockpile 110, for example to achieve a desired incident angle 906. In FIG. 9, the incident angle 906 is shown as a right or 90° angle, but other incident angles 906 such as 0°, 10°, 20°, 30°, 40°, 45°, 50°, 60°, 70°, 80°, 85°, or angles in between may be achieved as desired, for example to achieve better imaging coverage of a stockpile 110, prevent, reduce dust buildup on the imaging pod 300, image materials with different angles of repose 908, etc.

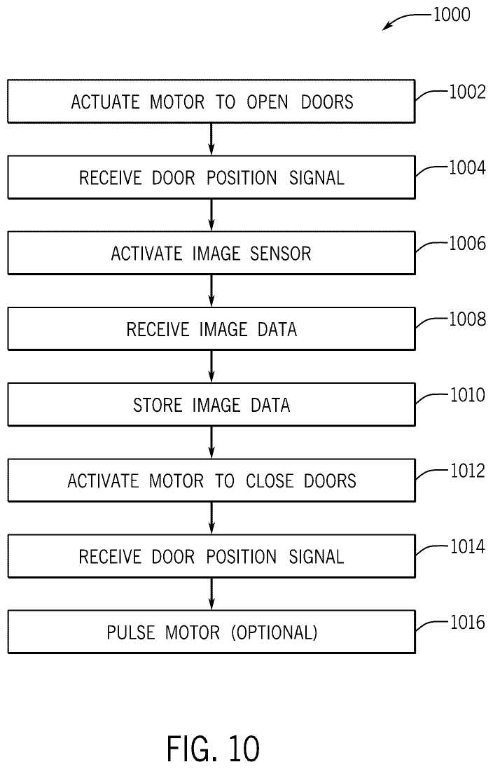

FIG. 10 illustrates an example method 1000 for acquiring image data via an imaging pod 300. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method 1000 includes activating the motor 720 of the drive assembly 700 or the drive assembly 760 to open the door 500 and the door 600. For example, the processing element 1302 of the imaging pod 300 may cause the windings of the drive assembly 700 or drive assembly 760 to be powered by a power supply that causes the motor 720 to turn the shaft 776. The shaft 776 causes the receiver 704, the hub 702, and the coupler 736 to rotate. The interface of the spline 728 with the receiver 508 in the driven hub 504 causes one of the door 500 or the door 600 to rotate. Resistance to the opening of the door 500 or door 600 may cause the motor 720 body to rotate in an opposite direction from the shaft 776, thereby causing the other of the door 500 or door 600 to rotate for example, due to the interface of the distal sleeve 770 with the coupler 736 at the opposite end of the motor 720 from the shaft 776.

According to some examples, the method 1000 includes receiving one or more door position signals at operation 1004. When the door 500 and/or 600 reach a certain level or rotation, the magnetic elements 734 coupled to the receiver 704 or distal sleeve 770 cause the respective proximity sensors 738 to generate a signal indicating that the door 500 and/or door 600 are in a desired open position. That open signal is received by the processing element 1302 which causes the motor 720 to stop rotating, for example by removing power from the motor 720.

According to some examples, the method 1000 includes activating the image sensor 422 at operation 1006. For example, the processing element 1302 may generate a command to the image sensor 422 causing the rotor 424 to rotate, and a light emitter, such as a laser, within the image sensor 422 to emit light. The rotation of the rotor 424 may cause the emitted light to scan at least a portion of the stockpile 110. As discussed herein, the rotation of the rotor 424 causes the air mover 404 to spin and generate an airflow 402 which may help clean the image sensor 422 and/or the imaging pod 300. The image sensor may be activated for a predetermined length of time to achieve sufficient image data of the stockpile 110. For example, the image sensor 422 may scan for 1, 2, 3, 4, 5, 6, 7, 8, 9, 10 or more minutes.

According to some examples, the method 1000 includes receiving image data at operation 1008. A portion of the emitted light is reflected from the stockpile 110 and received by the image sensor 422. By measuring the time elapsed between emitting the light and receiving the reflected light (e.g., the time of flight), the processing element 1302 can calculate a distance from the imaging pod 300 to the stockpile 110 based on the speed of light and the elapsed time. Thus, the image sensor 422 can generate depth or surface data about the stockpile 110. The generated data may be 3D data. For example, the 3D data may be a point cloud where each point represents a position in 3D space of a surface of the stockpile 110. In examples where methods other than LIDAR are used (e.g., photogrammetry), the image sensor 422 may not include a light emitter and may capture image data using ambient or artificial light from other sources (e.g., luminaires, windows, skylights, etc.).

According to some examples, the method 1000 includes storing the image data received in operation 1010. For example, the image data may be stored in a memory component 1308 included in the controller 320. In other examples, the image data may be transmitted to a separate storage device such as associated with a server 104 and/or the memory component 1308 of a different imaging pod 300 than the imaging pod 300 that captured the image data. When sufficient image data has been stored, the processing element 1302 may deactivate the image sensor 422 (e.g., turn off the light emitter and stop the rotor 424). A portion of the operation 1010 may occur at the same time as a portion of the operation 1006 and/or the operation 1008. For example, the image data may be received and stored while the image sensor 422 is active (e.g., image data may be streamed to the memory component 1308).

According to some examples, the method 1000 includes activating the motor 720 to close the doors 500 and 600 at operation 1012. The operation 1012 is often the reverse of the operation 1002 where a reverse rotation is applied by the motor 720 to the drive assembly 700 or drive assembly 760 to cause the door 500 and door 600 to rotate in a direction opposite the direction by which the door 500 or 600 opened.

According to some examples, the method 1000 includes receiving a door position signal at operation 1014. The operation 1014 is substantially similar to the operation 1004 in that a magnetic element 734 coupled to the receiver 704 of the distal sleeve 770 causes a respective proximity sensor 738 to generate a signal indicating that the door 500 and/or door 600 are closed. The magnetic element 734 in the operation 1014 is often a different magnetic element 734 than used in the operation 1004. For example, each of the receiver 704 and the distal sleeve 770 may include two magnetic elements 734, one adapted to indicate an open position of the door 500 and the door 600 and another to indicate a closed position of the door 500 and the door 600. When the magnetic element 734 indicating the closed position activates one or both proximity sensors 738, the processing element 1302 may cause the motor 720 to stop rotating.

According to some examples, the method 1000 includes pulsing the motor 720 (optional) at operation 1016. For example, if a certain time elapses after activating the motor 720 to close the door 500 or door 600, and a proximity sensor 738 has not yet indicated that the door 500 or door 600 are closed, the motor 720 may pulse (e.g., stop and start the motor 720 one or more times) or reverse the motor 720 and attempt to close the doors 500 and door 600 one or more additional times. Such actions may help dislodge accumulated material obstructing the door 500 or door 600 from closing. In some embodiments, if the doors 500 and door 600 are not able to be closed or opened, the processing element 1302 may issue an error, alert, or warning as one or more of a visual indication such as via a light emitter, an audible indication such as via an annunciator, and/or an electronic indication via the network 102. Thus, the imaging pod 300 may alert a user 106 for the need for maintenance of the imaging pod 300.

According to some examples of the measurement system 100, one or more imaging pods 300 may be designated as primary imaging pods 300. A primary imaging pod 300 coordinates the activity of the other imaging pods 300 in the measurement system 100. For example, the imaging pod 300 may initiate the method 1000 for itself, and then command each of the other imaging pods 300 to perform the method 1000. While in some embodiments, the execution of the method 1000 by the various imaging pods 300 may be at least partially simultaneous, often the execution of the method 1000 for each imaging pod 300 is sequential. For example, where a measurement system 100 includes four imaging pods 300 (as shown for example in FIG. 1), a first imaging pod 300 may be designated as the primary imaging pod 300 and the remaining three imaging pods 300 designated as secondary imaging pods 300. The primary imaging pod 300 may execute the method 1000 using its own drive assembly 700/760 and image sensor 422 and then generate and transmit a command (e.g., via the 102) to a first of the secondary imaging pods 300 to execute the method 1000. The primary imaging pod 300 may receive the image data from the first secondary imaging pod 300. When the first secondary imaging pod 300 completes the method 1000, the primary imaging pod 300 may command the second secondary imaging pod 300 to execute the method 1000, and so on for as many imaging pods 300 as are in a measurement system 100. Using such as serial approach has certain benefits. For example, power supply requirements for the measurement system 100 can be minimized as only one or two imaging pods 300 (e.g., the primary imaging pod 300 and one secondary imaging pod 300) may be active at a given time. Additionally, by serially executing the method 1000 with each imaging pod 300, the risk of emitted light from one imaging pod 300 being received and contaminating the image data of another imaging pod 300 is reduced or eliminated. In many embodiments, the primary imaging pod 300 may also generate the network 102. For example, each of the imaging pods 300 may include a network interface 1310 capable of creating or communicating with a network 102. In many embodiments, the network interface 1310 is a wireless interface such as Wi-Fi, Bluetooth, LTE, 5G, etc. The primary imaging pod 300 may be configured to generate a Wi-Fi network 102 and the secondary imaging pods 300 configured to join and communicate via the network 102 via their respective network interfaces 1310. In some embodiments, one or more of the imaging pods 300 may form a mech network. In some embodiments, an imaging pod 300 with the strongest or highest quality Wi-Fi signal may be used as the primary imaging pod, with pods having weaker or lower quality signals selected as secondary imaging pods.

The imaging pods 300 may include internal and/or external antennas to form or communicate with a wireless network or with other wireless devices. As shown for example in FIG. 3G, the bottom cap 314 or another component the imaging pod 300 may include a provision for one or more external radio antennas (e.g., one to transmit and one to receive) to support wireless communications such as through Wi-Fi, Bluetooth, LoRa, etc. For example, the bottom cap may include a blank, knockout, cutout or other feature that can receive an external antenna to boost the wireless range and capabilities of the imaging pod 300.

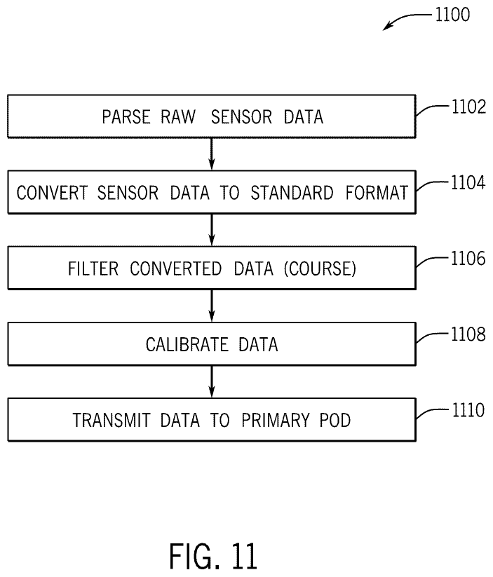

FIG. 11 illustrates an example method 1100 for pre-processing the image data received in the method 1000. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence. The operations of the method 1100 may be executed by a local processing element 1302 within an imaging pod 300 acquiring the raw image sensor 422 data (e.g., a primary or secondary imaging pod 300), a processing element 1302 remote from the imaging pod 300 acquiring the raw image sensor 422 data (e.g., a primary imaging pod 300), or another processing element 1302 (e.g., associated with the server 104).

According to some examples, the method 1100 includes parsing raw image sensor 422 data at operation 1102. For example, the raw image sensor 422 data may be subjected to one or more steps by the processing element 1302 in the imaging pod 300 whose image sensor 422 generates the data or another processing element 1302 (e.g., of a primary imaging pod 300 or the server 104). For example, raw image sensor 422 data may be consolidated by removing redundant data points. The raw image sensor 422 data may be down-sampled (e.g., data points averaged or aggregated over an area to reduce fidelity of the point could or surface but also reduce the size of the data). The raw image sensor 422 data may be subject to one or more quality checks. For example, the raw image sensor 422 data may be validated to remove spurious or impossible data (e.g., data that appears to float in mid-air as may be captured by scanning a moth). In another example, the raw image sensor 422 data may also be subjected to a de-noising algorithm.

According to some examples, the method 1100 includes converting the parsed sensor data from the operation 1102 to a standard format at operation 1104. For example, the processing element 1302 in the imaging pod 300 acquiring the data or another processing element 1302 of the measurement system 100 may convert the parsed data to a standardized format such as LIDARzip (LAZ) or LIDAR Aerial Survey (LAS) format. In many embodiments, the standard format is a vector data format. LAZ is a compressed LIDAR data format often used to transfer large amounts of LIDAR data. Advantages of converting the parsed data to LAZ or LAS format via the processing element 1302 that acquired the data includes conserving network 102 bandwidth and memory component 1308 resources, and interoperability with standard LIDAR software and hardware.

According to some examples, the method 1100 includes filtering converted data at operation 1106. For example, the processing element 1302 in the imaging pod 300 that converted the data in operation 1104 or another processing element 1302 of the measurement system 100 may down-sample the standardized data. For example, the processing element 1302 may apply a coarse filter that limits the standardized data to areas of the stockpile 110 desired to be captured by a particular imaging pod 300. For example, in a measurement system 100 with multiple imaging pods 300 there may be some overlap (including more than a desired overlap) of imaging coverage of the stockpile 110. The standardized data may be truncated to include only parts of the data that represent a desired portion of the stockpile 110 for a particular imaging pod 300.

In some embodiments of the operation 1106 (or another operation) the controller 320 or sensor 422 may determine a data quality metric of the sensor data. For example, the sensor may calculate a ratio or percentage of light pulses received compared to the number of light pulse sent. In some embodiments, the controller 320 or the sensor 422 may determine a quality index of the sensor data. In some embodiments, a quality index may be determined by the controller 320 or the sensor 422 on a per-scan basis in accordance with the following equation: quality index=(quality points/129,600)×100. As used herein “quality points” are determined by performing the following steps: (1) remove weak (i.e., low intensity) and near-saturated (i.e., high intensity) detected points such that only points having a value from 6 to 250 (e.g., when using 8-bit data with 256 possible values) remain; (2) filter the remaining points to remove any points within 0.15 m of the sensor 422; (3) down sample the data; and (4) filter points to remove any points within 0.5 m of the sensor 422.

In some embodiments, the data quality metric may be a dirty % of the data. For example, a dirty % may be calculated as (1−pulses received/pulses sent). For example, if a sensor 422 sends 1000 light pulses and receives back only 200 reflected pulse, the % dirty would be (1−200/1000=80%). Such dirty data may be indicative of a fouled, dirty, or otherwise impaired sensor 422 or imaging pod 300. When the data quality metric reaches a threshold level, the controller may generate a maintenance message or indicator and communicate the same to another part of the system 100 and/or a user. Continuing the previous example, if the maintenance threshold is 60% dirty data, and the actual dirty % is 80%, the controller 320 may generate a maintenance indication or message and transmit the same such that a user can service the imaging pod 300 that generated the message.

According to some examples, the method 1100 includes calibrating data at operation 1108. For example, the processing element 1302 in the imaging pod 300 that filtered the data in operation 1106 or another processing element 1302 of the measurement system 100 may calibrate the filtered data. For example, the processing element 1302 may align a point cloud or surface represented by the filtered data with respect to the stockpile 110, the storage location 112, the primary imaging pod 300, or other physical features. In some embodiments, the processing element 1302 may generate a 3D mesh based on the filtered data.

According to some examples, the method 1100 includes transmitting data to a primary imaging pod 300 at operation 1110. For example, the imaging pod 300 that acquired the image data in the method 1000 and executed the operations of the method 1100 to the raw image sensor 422 data may transmit the results of the method 1100 (i.e., refined image data) to the primary imaging pod 300. In cases where the primary imaging pod 300 is the imaging pod 300 executing the method 1100, the imaging pod 300 may store the results of the method 1100 in its memory component 1308 rather than transmit the results to another imaging pod 300. The transmission of the results of the method 1100 may be via the network 102 as previously described.

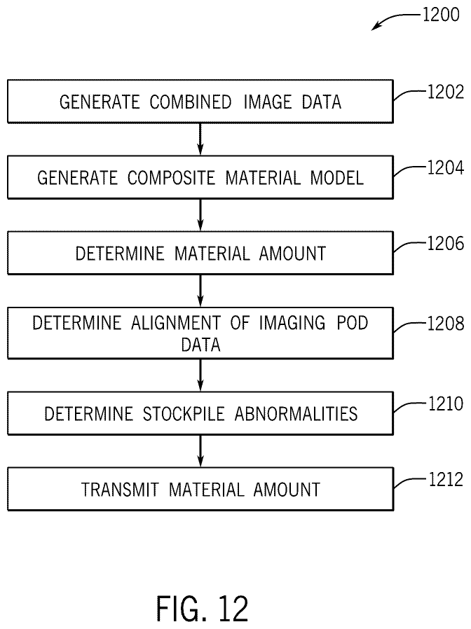

FIG. 12 illustrates an example method 1200 for determining the material amount in the stockpile 110 based on the results of the method 1000 and/or the method 1100. Although the example method 1200 depicts a particular sequence of operations, the sequence may be altered without departing from the scope of the present disclosure. For example, some of the operations depicted may be performed in parallel or in a different sequence that does not materially affect the function of the method 1200. In other examples, different components of an example device or system that implements the method 1200 may perform functions at substantially the same time or in a specific sequence. The operations of the method 1100 may be executed by a local processing element 1302 within an imaging pod 300 acquiring the raw image sensor 422 data (e.g., a primary or secondary imaging pod 300), a processing element 1302 remote from the imaging pod 300 acquiring the raw image sensor 422 data (e.g., a primary imaging pod 300), or another processing element 1302 (e.g., associated with the server 104).

According to some examples, the method 1200 includes generating combined image data at operation 1202. For example, the processing element 1302 in the primary imaging pod 300, having received the refined image data resulting from the execution of the method 1000 and the method 1100 by the secondary imaging pods 300, and the refined image data that the primary imaging pod 300 itself generated by execution of the method 1000 and the method 1100 may combine the refined image data from two or more of the imaging pods 300. For example, the primary imaging pod 300 may classify each point in a point cloud as belonging or not belonging to the stockpile 110.

According to some examples, the method 1200 includes generating a composite material model at operation 1204. For example, the processing element 1302 of the primary imaging pod 300 generates a composite material model based on the combined refined image data generated in the operation 1202. For example, the processing element 1302 may generate one or more of a surface model or a volumetric (e.g., 3D) model of the stockpile 110. The processing element 1302 may also determine a mass of the material in the stockpile 110. For example, the processing element 1302 may access a database or look-up table that correlates a material type in the stockpile 110 with a bulk density of the material. The mass of the material may be calculated as the product of the volume of the stockpile 110 and the bulk density (e.g., 50 lb./ft³*200,000 ft³=10 million pounds). Other units of measure than imperial (e.g., pounds and feet) may be used as desired, including tons, cubic yards, or the International System of Units (e.g., “SI” or metric) units, etc.

According to some examples, the method 1200 includes determining a material amount at operation 1206. For example, the processing element 1302 of the primary imaging pod 300 may determine a volume of the composite material model such as by numerical integration or other methods.

According to some examples, the method 1200 includes determining alignment of imaging pod 300 data at operation 1208. For example, the processing element 1302 may utilize an alignment checking algorithm to determine metrics describing each imaging pod 300's data collection status. For example, the processing element 1302 may tracking if there is any significant movement, occlusion or other issues that can potentially cause issues in stockpile 110 monitoring.

According to some examples, the method 1200 includes determining stockpile abnormalities at operation 1210. For example, based on the output of the operation 1208, the processing element 1302 may determine whether any inconsistencies in the stockpile 110 are present. For example, if there is a large, unexpected change in volume or shape of the stockpile 110, the processing element 1302 may rescan the stockpile 110 (e.g., re-execute one or more operations of the method 1000, method 1100, and/or method 1200). In another example, the processing element 1302 may adjust the material amount determined in the operation 1206 based on the abnormalities determined in the operation 1210.

According to some examples, the method 1200 includes transmitting the material amount at operation 1212. For example, the processing element 1302 may transmit the material amount (either or both of volume and mass) and either as determined in the operation 1206 or the operation 1210, along with other data related to the methods 1000, method 1100, and/or method 1200 such as the imaging pod 300 maintenance status, time of data capture, data quality metrics, etc. The material amount may be transmitted from the primary imaging pod 300 to another computing device such as another imaging pod 300, the server 104, the user device 108, and/or another device, through the network 102 or another network (e.g., a cellular telephone network).

In some examples, the method 1000, the method 1100, and/or the method 1200 may be executed on an empty storage location 112. For example, it may be advantageous to generate calibration data of the storage location 112 for comparison against image data when the storage location 112 includes a stockpile 110 to help determine the volume, mass, or shape (or changes thereto) of the stockpile 110.

In some embodiments, the method 1000, the method 1100, and/or the method 1200 may be executed by a measurement system 100 including one or more imaging pods 300 positioned above a travel lane of a truck carrying a material. For example, the measurement system 100 may scan the payload of the truck as it passes under one or more imaging pods 300 and the measurement system 100 may determine the material amount in the truck using the methods and systems disclosed herein.

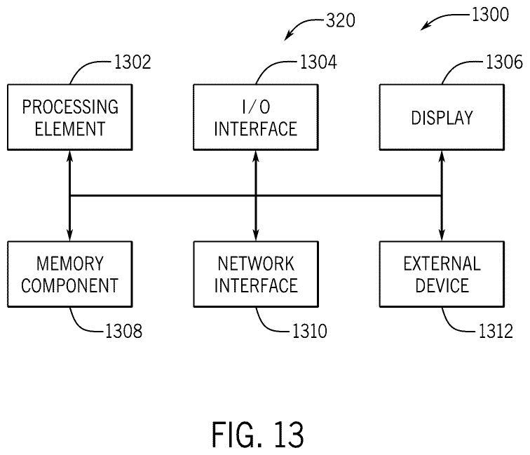

FIG. 13 is a simplified block diagram of components of a computing system 1300 or a controller 320 of the system 100, such as the server 104, an imaging pod 300, the user device 108, etc. For example, the processing element 1302 and the memory component 1308 may be located at one or in several computing systems 1300. This disclosure contemplates any suitable number of such computing systems 1300. For example, the server 104 may be a desktop computing system, a mainframe, a blade, a mesh of computing systems 1300, a laptop or notebook computing system 1300, a tablet computing system 1300, an embedded computing system 1300, a system-on-chip, a single-board computing system 1300, or a combination of two or more of these. Where appropriate, a computing system 1300 may include one or more computing systems 1300; be unitary or distributed; span multiple locations; span multiple machines; span multiple data centers; or reside in a cloud, which may include one or more cloud components in one or more networks. A computing system 1300 may include one or more processing elements 1302, an input/output I/O interface 1304, one or more external devices 1312, one or more memory components 608, and a network interface 1310. Each of the various components may be in communication with one another through one or more buses or communication networks, such as wired or wireless networks, e.g., the network 102. The components in FIG. 13 are exemplary only. In various examples, the computing system 1300 may include additional components and/or functionality not shown in FIG. 13.

The processing element 1302 may be any type of electronic device capable of processing, receiving, and/or transmitting instructions. For example, the processing element 1302 may be a central processing unit, microprocessor, processor, or microcontroller. Additionally, it should be noted that some components of the computing system 1300 may be controlled by a first processing element 1302 and other components may be controlled by a second processing element 1302, where the first and second processing elements may or may not be in communication with each other.

The I/O interface 1304 allows a user to enter data in to computing system 1300, as well as provides an input/output for the computing system 1300 to communicate with other devices or services. The I/O interface 1304 can include one or more input buttons, touch pads, touch screens, and so on.

The external device 1312 are one or more devices that can be used to provide various inputs to the computing systems 600, e.g., mouse, microphone, keyboard, trackpad, sensing element (e.g., a thermistor, humidity sensor, light detector, etc. The external devices 1312 may be local or remote and may vary as desired. In some examples, the external devices 1312 may also include one or more additional sensors.

The memory components 1308 are used by the computing system 1300 to store instructions for the processing element 1302 such as the instructions to execute the method 1000, the method 1100 and/or the method 1200, raw image sensor 422 data, refined image data, or data in various states therebetween, material amounts, error and status messages, user preferences, alerts, etc. The memory components 1308 may be, for example, magneto-optical storage, read-only memory, random access memory, erasable programmable memory, flash memory, or a combination of one or more types of memory components.

The network interface 1310 provides communication to and from the computing system 1300 to other devices. The network interface 1310 includes one or more communication protocols, such as, but not limited to Wi-Fi, Ethernet, Bluetooth, etc. The network interface 1310 may also include one or more hardwired components, such as a Universal Serial Bus (USB) cable, or the like. The configuration of the network interface 1310 depends on the types of communication desired and may be modified to communicate via Wi-Fi, Bluetooth, etc.

The display 1306 is optional in some devices (e.g., the imaging pods 300) provides a visual output for the computing system 1300 and may be varied as needed based on the device. The display 1306 may be configured to provide visual feedback to the user 106 and may include a liquid crystal display screen, light emitting diode screen, plasma screen, or the like. In some examples, the display 1306 may be configured to act as an input element for the user 106 through touch feedback or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, primary, secondary, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A system for measuring an amount of a material, comprising:
a first imaging pod positioned at a first position relative to a stockpile of the material;
a second imaging pod in communication with the first imaging pod and positioned at a second position relative to the stockpile of material different than the first position;
a processor configured to:
receive the data about the stockpile from the imaging pods; and
determine a characteristic of the stockpile based on the data.

2. The system of claim 1, wherein the characteristic comprises an amount of the material.

3. The system of claim 2, wherein the processor is further configured to:
determine a composite surface model based on the data;
receive a bulk density of the material; and
determine the amount of the material based on the composite surface material model and the bulk density.

4. The system of claim 3, wherein the amount of the material comprises at least one of a weight of the material, a volume of the material, a change in the weight of the material, or a change in the volume of the material.

5. The system of claim 2, wherein the processor is further configured to receive calibration data about a storage facility configured to receive the stockpile, and generate the amount of the material based on the calibration data.

6. The system of claim 1, wherein at least one of the first imaging pod or the second imaging pod comprises:
a housing including a selectively moveable door;
a sensor disposed within the housing and selectively revealeable responsive to the selective movement of the door, wherein when the sensor is revealed, the sensor is configured to capture the data.

7. The system of claim 6, wherein at least one of the first imaging pod or the second imaging pod further comprises a drive assembly rotationally coupled to the door, wherein:
the drive assembly rotationally floats with respect to the housing; and
the drive assembly is selectively collapsible.

8. (canceled)

9. (canceled)

10. The system of claim 1, wherein:
the first imaging pod is configured as a primary imaging pod including the processor;
the second imaging pod is configured as a secondary imaging pod; and
the primary imaging pod is configured to command, via the processor, the secondary imaging pod to:
activate a sensor in the secondary imaging pod;
capture the data, via the sensor, of the stockpile from the second location; and
transmit the data to the primary image pod.

11. (canceled)

12. The system of claim 1, wherein the imaging pods are configured to reduce or remove debris from an image sensor coupled thereto.

13. A sensing pod for capturing data of a surface of a material stockpile, comprising:
a housing including a selectively moveable door;
a sensor disposed within the housing and selectively revealeable responsive to the selective movement of the door, wherein when the sensor is revealed, the sensor is configured to capture the data of the surface of the stockpile.

14. The sensing pod of claim 13, further comprising a drive assembly rotationally coupled to the door.

15. The sensing pod of claim 14, wherein the drive assembly rotationally floats with respect to the housing.

16. The sensing pod of claim 14, wherein the drive assembly is selectively collapsible.

17. (canceled)

18. The sensing pod of claim 13, further comprising a sensor assembly comprising:
the sensor;
a stationary hub;
a rotationally moveable rotor coupled to the hub; and
an air mover coupled to the rotor, wherein when the sensor captures the image data, the rotor rotates relative to the hub and the rotation of the rotor causes the air mover to generate an airflow.

19. The sensing pod of claim 18, wherein the airflow is configured to remove or prevent debris buildup on the sensing pod.

20. The sensing pod of claim 13, further comprising a mount configured to position the sensing pod relative to a support surface and relative to the stockpile.

21. The sensing pod of claim 20, wherein the configuration of the position of the sensing pod is based, at least in part, on an angle of repose of the material.

22. The sensing pod of claim 13, further comprising a processing element configured to determine at least one of a weight or a volume of the material in the stockpile based on the data.

23. A method of determining an amount of a material, comprising:
receiving, by a processor, first image data of the material, from a first imaging pod;
receiving, by the processor, second image data of the material from a second imaging pod at a different location than the first imaging pod relative to the amount of the material;
stitching, by the processor, the first image data and the second image data together to generate a composite surface model of the material;
receiving, by the processor, a bulk density of the material;
receiving, by the processor, calibration data about the storage facility; and
generating, by the processor, at least one of a weight or a volume of the amount of the material based on the composite surface material model, the bulk density, and the calibration data.

24. The method of claim 23, wherein the processor is associated either the first imaging pod or the second imaging pod and the processor receives the second image data from the other of the first imaging pod or the second imaging pod.

25. (canceled)

26. (canceled)
